(19) United States
(12) Patent Application Publication
(10) Pub. No.: US 2015/0056423 A1
(43) Pub. Date: Feb. 26, 2015

(54) IMAGE FORMING APPARATUS, IMAGE FORMING METHOD, AND METHOD OF MANUFACTURING PRINTED MATTER

(71) Applicants: Kazuki Yasu, Kanagawa (JP); Yoshinari Suzuki, Kanagawa (JP); Yukihito Niino, Tokyo (JP)

(72) Inventors: Kazuki Yasu, Kanagawa (JP); Yoshinari Suzuki, Kanagawa (JP); Yukihito Niino, Tokyo (JP)

(73) Assignee: RICOH COMPANY, LTD., Tokyo (JP)

(21) Appl. No.: 14/465,776

(22) Filed: Aug. 21, 2014

(30) Foreign Application Priority Data
Aug. 26, 2013 (JP) 2013-174369

(51) Int. Cl. B41J 11/00

(52) U.S. Cl. CPC B41J 11/0015
USPC 428/203; 347/21

(57) ABSTRACT

An image forming apparatus discharging liquid droplets onto a recording medium to form an image on a surface of the recording medium, includes a preprocess unit configured to apply a preprocess liquid to the surface of the recording medium before the image is formed; and a postprocess unit configured to discharge a postprocess liquid onto the surface of the recording medium after the image has been formed, the postprocess liquid being different from the preprocess liquid. The preprocess unit applies the preprocess liquid with an amount of the preprocess liquid determined based on at least image forming speed of the image to be formed on the recording medium. The postprocess unit discharges the postprocess liquid with an amount of the postprocess liquid determined based on at least the image forming speed.

### CROSS-REFERENCE TO RELATED APPLICATIONS

The present application claims priority to and incorporates by reference the entire contents of Japanese Patent Application No. 2013-174369 filed in Japan on Aug. 26, 2013.

### BACKGROUND OF THE INVENTION

1. Field of the Invention

The disclosures herein generally relate to an image forming apparatus, an image forming method, and a method of manufacturing a printed matter.

2. Description of the Related Art

Image forming apparatuses include inkjet type image forming apparatuses that have advantages in downsizing and low-noise. In the inkjet type image forming method, droplets of ink are discharged onto a recording medium to form an image on a surface of the recording medium.

Patent Document 1 discloses an inkjet recording apparatus (image forming apparatus) that applies process liquid including an ingredient to insolubilize or agglutinate an ingredient in ink, by separating a preprocess to discharge the process liquid onto the recording medium before discharging the ink, from a postprocess to discharge the process liquid after the ink has been discharged onto the recording medium, to reduce a difference between quality levels of the recording medium in the preprocess and in the postprocess.

The method disclosed in Patent Document 1 applies the process liquid to the surface of the recording medium where the process liquid includes the ingredient to insolubilize or agglutinate an ingredient in the ink. However, there is a problem that when the surface of the recording medium having an image formed is abraded by another object (for example, another recording medium), the image on the recording medium may be peeled. Also, when an image forming speed (recording speed or conveyance speed) is high and adjacent droplets of ink are discharged before previously discharged droplets have not yet been agglutinated, blurred ink may degrade the quality of the image being formed. However, Patent Document 1 does not disclose a technology relating to the quality of an image being formed and image forming speed.

### RELATED-ART DOCUMENTS

### Patent Documents

[Patent Document 1] Japanese Laid-open Patent Publication No. H10-226055

### SUMMARY OF THE INVENTION

In view of the above, it is a general object of at least one embodiment of the present invention to provide an image forming apparatus that substantially obviates one or more problems caused by the limitations and disadvantages of the related art.

According to at least one embodiment of the present invention, an image forming apparatus discharging liquid droplets on a recording medium to form an image on a surface of the recording medium, includes a preprocess unit configured to apply a preprocess liquid to the surface of the recording medium before the image is formed; and a postprocess unit configured to discharge a postprocess liquid on the surface of the recording medium after the image has been formed, the postprocess liquid being different from the preprocess liquid. The preprocess unit applies the preprocess liquid with an amount of the preprocess liquid determined based on at least the image forming speed of the image to be formed on the recording medium. The postprocess unit discharges the postprocess liquid with an amount of the postprocess liquid determined based on at least the image forming speed.

According to at least one embodiment of the present invention, it is possible to provide an image forming apparatus that forms an image based on image forming speed, and improves the rub resistance of the recording medium on which the image is formed.

### BRIEF DESCRIPTION OF THE DRAWINGS

Other objects and further features of embodiments will be apparent from the following detailed description when read in conjunction with the accompanying drawings, in which:

FIG. 1 is a diagram illustrating an example of a side view of an image forming apparatus according to an embodiment of the present invention;

FIG. 2 is a diagram illustrating an example of a configuration of a preprocess unit in the image forming apparatus according to the present embodiment;

FIG. 3 is a diagram illustrating an example of a configuration of a drying unit in the image forming apparatus according to the present embodiment;

FIGS. 4A and 4B are explanatory diagrams illustrating examples of an image forming unit and a postprocess unit in the image forming apparatus according to the present embodiment;

FIGS. 5A and 5B are cross-sectional diagrams illustrating an example of the image forming unit in the image forming apparatus according to the present embodiment;

FIG. 6 is an explanatory diagram illustrating an example of a recording medium (a product or a printed matter) having an image formed by the image forming apparatus according to the present embodiment;

FIGS. 7A and 7B are diagrams illustrating examples of a control unit in the image forming apparatus according to the present embodiment;

FIG. 8 is a functional block diagram illustrating an example of functions of the control unit in the image forming apparatus according to the present embodiment;

FIG. 9 is a functional block diagram illustrating an example of a data management unit of the control unit in the image forming apparatus according to the present embodiment;

FIG. 10 is a functional block diagram illustrating an example of an image output unit of the control unit in the image forming apparatus according to the present embodiment;

FIG. 11 is a flowchart illustrating an example of operations of an image forming apparatus according to a first example;

FIG. 12 is an explanatory diagram illustrating an example of a relationship between an application amount and granularity of preprocess liquid in the image forming apparatus according to the first example; and

FIG. 13 is a flowchart illustrating an example of operations of an image forming apparatus according to a second example.

### DESCRIPTION OF THE PREFERRED EMBODIMENTS

In the following, embodiments of the present invention will be described with an inkjet type image forming apparatus, with reference to the accompanying drawings. The present invention can be applied not only to an image forming apparatus as will be described in the following, but also to any other apparatuses that form (print, copy, type, record or the like) images on a surface of a recording medium by discharging droplets of ink or toner from a discharger (a discharge head, an ink head, a recording head, an inkjet, etc.), which include a printer, a scanner, a copy machine, a plotter, a facsimile, and the like.

Embodiments of the present invention will be described in the following order, using an image forming apparatus.

1. Configuration of image forming apparatus
1-1. Configuration of take-in unit
1-2. Configuration of preprocess unit
1-3. Configuration of drying unit
1-4. Configuration of image forming unit
1-5. Configuration of postprocess unit
1-6. Configuration of take-out unit
1-7. Configuration of control unit
2. Operations of image forming apparatus
2-1. Operations of preprocess unit
2-2. Operations of postprocess unit
2-3. Operations of drying unit
2-4. Control based on type of recording medium
2-5. Control based on resolution of image
2-6. Control based on type of ink
3. First example (image forming method)
4. Second example (image forming method) (liquid amount adjustment for postprocessing is added to first example)

### 1. Configuration of Image Forming Apparatus

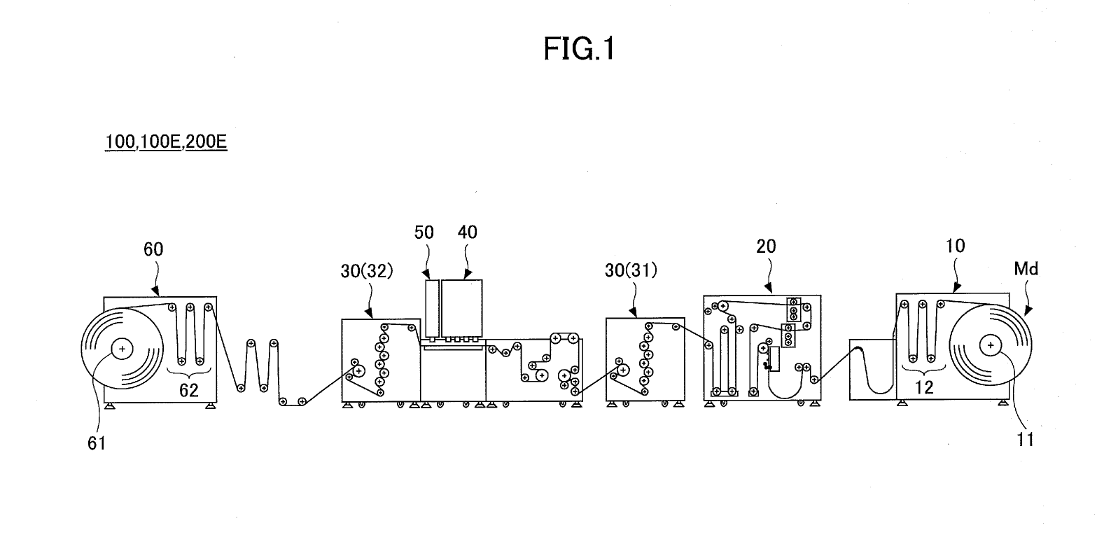

An image forming apparatus 100 will be described with reference to FIGS. 1-5 according to an embodiment of the present invention.

In the present embodiment, the image forming apparatus 100 will be described that includes discharge heads (recording heads or ink heads) for four colors, i.e. black (K), cyan (C), magenta (M) and yellow (Y), but it is not limited to this image forming apparatus having these discharge heads. Namely, the image forming apparatus of the present embodiment may further include discharge heads to deal with green (G), red (R), light cyan (LC), and/or other colors, or may only include the discharge head for black (K). In the following description, a numerical symbol having a suffix of K, C, M or Y attached corresponds to black, cyan, magenta or yellow, respectively.

Also, although a rolled up continuous paper (referred to as “rolled paper Md” below) is adopted as a recording medium in the present embodiment, a recording medium on which an image can be formed by the image forming apparatus according to the present invention is not limited to the rolled paper. Namely, the recording medium on which an image can be formed by the image forming apparatus according to the present invention may be a cut sheet. Other recording media on which an image can be formed by the image forming apparatus according to the present invention may include standard paper, high quality paper, thin paper, thick paper, a recording sheet, a rolled paper, an OHP sheet, a synthetic resin film, a metal thin film, and any other medium on which an image can be formed by ink or the like. Here, the rolled paper is a continuous paper longer than a fixed-size sheet. The rolled paper also includes sheets of paper to be cut off at perforations formed at predetermined intervals, or unperforated rolled paper. A page of the continuous business forms of perforated paper corresponds to, for example, an area between the perforations.

As shown in FIG. 1, the image forming apparatus 100 according to the present embodiment includes a take-in unit 10 to take in a rolled paper Md (recording medium), a preprocess unit 20 to apply a preprocess to the taken-in rolled paper Md, and a drying unit 30 to dry the rolled paper Md having the preprocess applied. The image forming apparatus 100 also includes an image forming unit 40 to form an image on the rolled paper Md, a postprocess unit 50 to apply a postprocess to the rolled paper Md on which the image is formed, and a take-out unit 60 to take out the rolled paper Md having the postprocess applied. The image forming apparatus 100 further includes a control unit 70 (not shown) to control operations of the image forming apparatus 100.

The image forming apparatus 100 according to the present embodiment takes in the rolled paper Md by the take-in unit 10, applies the preprocess to the rolled paper Md by the preprocess unit 20, and dries the rolled paper Md by the drying unit 30. Also, the image forming apparatus 100 forms an image on the preprocessed and dried surface of the rolled paper Md by the image forming unit 40. Then, the image forming apparatus 100 applies the postprocess to the surface of the rolled paper Md by the postprocess unit 50. After that, the image forming apparatus rolls up (discharges or takes out) the rolled paper Md.

In the following, each of the units in the image forming apparatus 100 according to the present embodiment will be specifically described. The image forming apparatus 100 according to the present embodiment controls the preprocess unit 20, the drying unit 30, and the postprocess unit 50 based on at least speed to form an image on a recording medium (also called “image forming speed”, “recording speed”, or “conveyance speed”, although referred to as the “image forming speed” below). The image forming apparatus 100 may be configured without one or more of the units such as the preprocess unit 20 as will be described later.

1-1. Configuration of Take-in Unit

The take-in unit is a unit to convey the recording medium to the preprocess unit 20 or the like. The take-in unit 10 includes a paper feeding unit 11 and multiple conveyance rollers 12 according to the present embodiment. Using the conveyance rollers 12, the take-in unit 10 takes in (moves) the rolled paper Md to be wound around a feed paper roll and held in the paper feeding unit 11, and conveys the rolled paper to the preprocess unit 20 as will be described later.

1-2. Configuration of Preprocess Unit

The preprocess unit 20 is a unit to apply a preprocess to the recording medium before forming an image. The preprocess unit 20 according to the present embodiment applies a preprocess liquid to the recording medium where the amount of the preprocess liquid is determined based on at least the image forming speed. In the present embodiment, the preprocess unit 20 applies the preprocess liquid to the surface of the rolled paper Md that has been conveyed by the take-in unit 10.

The preprocessing here is a process to uniformly apply the preprocess liquid to the surface of the rolled paper Md (recording medium), and the preprocess liquid has a function to aggregate ink droplets.

The preprocess unit 20 in the image forming apparatus 100 according to the present embodiment may control the amount of the preprocess liquid to be applied by further using the resolution (the number of dots per unit area) of an image to be formed on the recording medium. This makes it possible for the image forming unit 100, when forming an image on a recording medium other than paper for the inkjet, to apply a preprocess liquid having a function to agglutinate the ink to the surface of the recording medium, by using the preprocess unit 20, before forming the image on the recording medium. Accordingly, the image forming apparatus 100 can reduce occurrences of quality problems of formed images relating to blurring, density, color tone, and strike through, as well as other problems relating to durability of the images, such as water-repellency and weatherability. Namely, the image forming apparatus 100 can improve the quality of an image to be formed, by applying the preprocess liquid having the function to agglutinate the ink by using the preprocess unit 20 before forming the image on the recording medium.

Note that the image forming unit 100 may apply the preprocess liquid having the function to agglutinate ink to the paper (recording medium) for the inkjet, by using the preprocess unit 20 before forming an image.

The preprocess unit 20 of the image forming apparatus 100 according to the present embodiment can use various preprocess methods, for example, a blade coating method, a gravure coating method, a gravure offset coating method, a bar-coating method, a roll coating method, a knife coating method, an air knife coating method, a comma coating method, a U comma coating method, an AKKU coating method, a smoothing coating method, a micro gravure coating method, a reverse roll coating method, a 4- or 5-rolls coating method, a dip coating method, a curtain coating method, a slide coating method, and a dye coating method.

Also, the preprocess unit 20 according to the present embodiment may use, as the preprocess liquid, for example, process liquid including hydrosoluble aliphatic organic acid. Note that the process liquid including hydrosoluble aliphatic organic acid has a function to agglutinate water-dispersible colorant particles. To “agglutinate” means that the water dispersible colorant particles adhere and aggregate with each other.

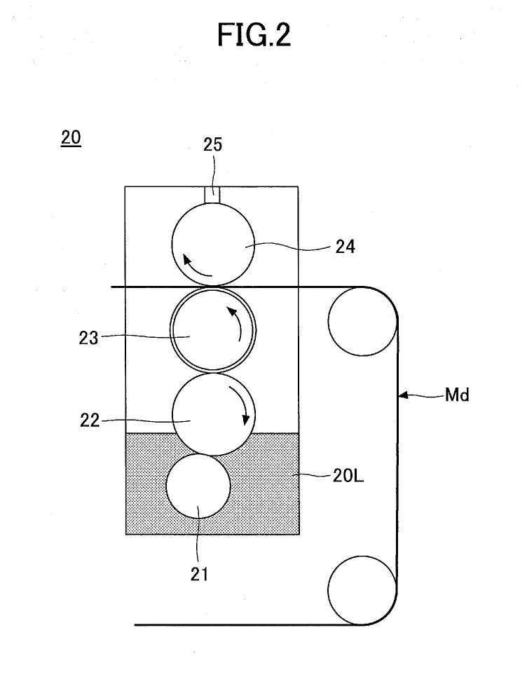

Furthermore, the preprocess unit 20 according to the present embodiment can make ions absorbed on the surfaces of the water dispersible colorant particles by adding an ionic material such as a hydrosoluble aliphatic organic acid or the like to the preprocess liquid. Accordingly, the preprocess unit 20 can neutralize charges on the surfaces of the water dispersible colorant particles. The preprocess unit 20 can also improve the agglutination by intermolecular force to further aggregate the water dispersible colorant particles. An example of the preprocess unit 20 using a roll coat method will be described with reference to FIG. 2.

As shown in FIG. 2, the preprocess unit 20 applies stored preprocess liquid 20L to the surface of the rolled paper Md that has been taken (conveyed) into the preprocess unit 20 by the take-in unit 10 (FIG. 1) according to the present embodiment.

Specifically, first, the preprocess unit 20 transcribes (transfers) the preprocess liquid 20L onto the surface of an application roller 23 as a thin film by a stirring (feeding) roller 21 and a thin-film-forming (transferring) roller 22. Next, the preprocess unit 20 presses the application roller 23 against a platen roller 24, which is rotating, to rotate the application roller 23. Then, the preprocess unit 20 has the rolled paper Md conveyed into a nip between the application roller 23 and the platen roller 24 to apply the preprocess liquid 20L to the surface of the rolled paper Md.

The preprocess unit 20 also controls a nip pressure (pressure applied at a position where the application roller 23 contacts the platen roller 24) when applying the preprocess liquid 20L by using a pressure adjustment unit 25. By changing the nip pressure by using the pressure adjustment unit 25, the preprocess unit 20 can control (change) an application amount (film thickness, liquid amount, adherence amount, dried adherence amount, etc.) of the preprocess liquid 20L. Furthermore, the preprocess unit 20 controls rotational speed of the application roller 23 and the platen roller 24. By changing the rotational speed of the application roller 23, the preprocess unit 20 can control (change) the application amount of the preprocess liquid 20L. Note that the preprocess unit 20 may control the rotational speed of the application roller 23 and the like by, for example, controlling operation of a power source (not shown) such as a drive motor that drives the application roller 23 and the platen roller 24.

Thus, the preprocess unit 20 of the image forming apparatus 100 according to the present embodiment can apply the preprocess liquid 20L more uniformly to the rolled paper Md (recording medium) by using the application roller 23 and the like, compared with a case using an injection head to apply the preprocess liquid onto the recording medium. Namely, the preprocess unit 20 according to the present embodiment can apply the preprocess liquid to the roller paper Md thinly and uniformly even if using a preprocess liquid having relatively high viscosity. Thinly and uniformly applied with the preprocess liquid 20L by the preprocess unit 20 according to the present embodiment, the recording medium can be made less susceptible to blurring or the like on formed images, which improves quality of the images.

Also, the preprocess unit 20 of the image forming apparatus 100 according to the present embodiment can control the application amount (film thickness, liquid amount, adherence amount, dried adherence amount, etc.) of the preprocess liquid 20L applied by using the application roller 23 and the like. Therefore, the preprocess unit 20 according to the present embodiment can apply the preprocess liquid 20L to the surface of the rolled paper Md (recording medium) with an application amount that is appropriate for later image forming and postprocessing.

Furthermore, the application amount of the preprocess liquid can be controlled based on a type of the recording medium because the preprocess unit 20 of the image forming apparatus 100 according to the present embodiment can control the application amount of the preprocess liquid to be applied by using the application roller 23 and the like.

Furthermore, the application amount of the preprocess liquid can be reduced when the image forming speed is lower because the preprocess unit 20 of the image forming apparatus 100 according to the present embodiment can control the application amount of the preprocess liquid to be applied based on the image forming speed of an image (recording speed). Namely, the preprocess unit 20 according to the present embodiment consumes a less amount of the preprocess liquid when the image forming speed is lower; and hence, the cost relating to forming an image can be reduced. Also, the preprocess unit 20 according to the present embodiment can increase the amount of the preprocess liquid when the image forming speed becomes higher, which avoids beading to improve the image quality. Also, the preprocessing unit 20 can reduce the preprocessing liquid amount when a recording medium has small permeability and the image forming speed is low, by controlling the amount of the preprocessing liquid further based on the type of the recording medium, the resolution of an image to be formed, and/or the type of ink.

1-3. Configuration of Drying Unit

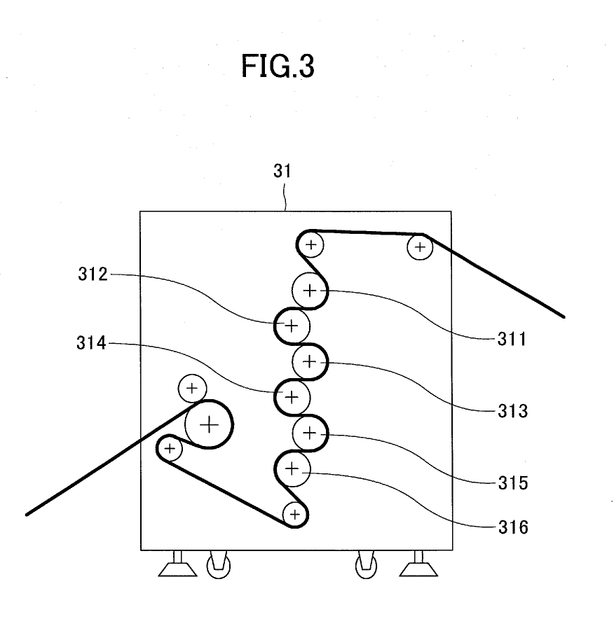

The drying unit 30 is a unit that dries the recording medium by heat or the like. The drying unit 30 according to the present embodiment heats the recording medium with drying strength determined based on at least the image forming speed. As shown in FIG. 1, the drying unit 30 according to the present embodiment includes a preprocess liquid drying unit 31 to dry the rolled paper Md preprocessed by the preprocess unit 20, and a postprocess liquid drying unit 32 to dry the rolled paper Md postprocessed by the postprocess unit 50. The drying unit 30 of the image forming unit 100 according to the present embodiment controls drying strength for the preprocess liquid in the preprocess liquid drying unit 31 and drying strength for the postprocess liquid in the postprocess liquid drying unit 32 based on at least the image forming speed to dry the rolled paper Md. A configuration of the preprocess liquid drying unit 31 will be described with reference to FIG. 3.

As shown in FIG. 3, the preprocess liquid drying unit 31 uses multiple heat rollers 311-316 to improve the drying effect according to the present embodiment. Also, the preprocess liquid drying unit 31 controls (changes) the drying strength (drying strength for the preprocess liquid) based on at least the image forming speed. Furthermore, the preprocess liquid drying unit 31 can further control the drying strength using the application amount per unit area on the surface of the recording medium that has been applied by the preprocess unit 20.

Specifically, the preprocess liquid drying unit 31 heats the heat rollers 311-316 at, for example, 40 to 100° C., and makes the surface of the rolled paper Md having the preprocess liquid applied contact the heat rollers 311-316. Accordingly, the preprocess liquid drying unit 31 can heat the surface of the rolled paper Md having the preprocess liquid applied, by the heat rollers 311-316 to evaporate water in the preprocess liquid, and to dry the rolled paper Md.

Also, the preprocess liquid drying unit 31 lowers the temperature of the heat rollers 311-316 when decreasing the drying strength. The preprocess liquid drying unit 31 decreases the drying strength when using ink with low permeability, and increases the drying strength when using ink with high permeability. The preprocess liquid drying unit 31 sets the temperature of the heat rollers 311-316 to, for example, 40 to 80° C.

Furthermore, the preprocess liquid drying unit 31 may increase or decrease the drying strength by increasing or decreasing the number of heat rollers used for heating, for example, by heating only the heat rollers 311 and 312, and not heating the others. Note that although the described example in the present embodiment controls both the temperature of heat rollers and the numbers of used heat rollers, the drying strength may be controlled by one of the temperature and the number of the heat rollers.

The configuration of the postprocess liquid drying unit 32 is the same as the preprocess liquid drying unit 31, and its description is omitted. Note that the postprocess liquid drying unit 32 controls drying strength (drying strength for the postprocess liquid) based on at least the image forming speed. Also, the postprocess liquid drying unit 32 may control the drying strength further using the discharge amount per unit area on the surface of the recording medium discharged by the postprocess unit 50.

Thus, the drying unit 30 of the image forming apparatus 100 according to the present embodiment (the preprocess liquid drying unit 31 and the postprocess liquid drying unit 32) can control the drying strength by a combination of the temperature of the heat rollers and the number of the heat rollers to be used. Also, the drying strength for the recording medium can be optimized based on at least the image forming speed used for forming an image on the surface of the recording medium because the drying unit 30 of the image forming apparatus 100 according to the present embodiment can control the drying strength. Furthermore, by controlling the drying strength for the preprocess liquid based on at least the image forming speed, the drying unit 30 of the image forming apparatus 100 according to the present embodiment can suppress an occurrence of degradation of image quality due to insufficient drying for the preprocess liquid and shrinkage of paper due to excessive drying. Namely, the image forming apparatus 100 according to the present embodiment can improve the image forming quality (print quality).

In the inkjet type image forming apparatus, when discharging droplets onto a recording medium under a certain condition, ink may be prepared with various additives such as glycerin in order to maintain constant physical properties such as viscosity and surface tension. Therefore, when the image forming apparatus uses ink prepared as above, permeability of the ink into the recording medium or glossiness after printing may be different depending on at least the image forming speed. The drying unit 30 of the image forming apparatus 100 according to the present embodiment can dry up the preprocess liquid or the postprocess liquid depending on at least the image forming speed even if an image is formed by ink having low permeability into the recording medium. The drying unit 30 according to the present embodiment can avoid generation of a problem such that an image on the recording medium is peeled when the surface of the recording medium is abraded by another object (for example, another recording medium) before the postprocess liquid has dried. The drying unit 30 according to the present embodiment can also suppress shrinkage of a recording medium due to excessive drying when forming an image by using ink with high permeability into the recording medium.

Furthermore, the drying unit 30 of the image forming apparatus 100 according to the present embodiment can reduce the power consumption used for the drying because it can reduce the drying strength based on the image forming speed of an image. Namely, the drying unit 30 according to the present embodiment can reduce the power consumption used for the drying to reduce the cost relating to image forming. Also, the drying unit 30 can increase the drying strength when the image forming speed becomes greater, and hence, can dry the recording medium by giving sufficient drying energy to the recording medium even if the image forming speed of the recording medium becomes greater and the drying time becomes shorter.

Note that the drying unit 30 according to the present embodiment is not limited to the one using the heating rollers to heat a recording medium. Namely, the drying unit 30 may use an infrared ray drying method, a microwave drying method, a hot-air drying method, and any other drying methods. Also, the drying unit 30 may use a drying method that combines multiple drying methods. Furthermore, the drying unit 30 may preheat the rolled paper Md (recording medium) before the preprocess unit 20 applies the preprocess liquid (preheat process (not shown)).

1-4. Configuration of Image Forming Unit

The image forming unit 40 is a unit to form an image on a recording medium. The image forming unit 40 according to the present embodiment forms an image on a surface of the rolled paper Md by discharging droplets (referred to as “ink” below) onto the rolled paper Md that has been dried by the drying unit 30.

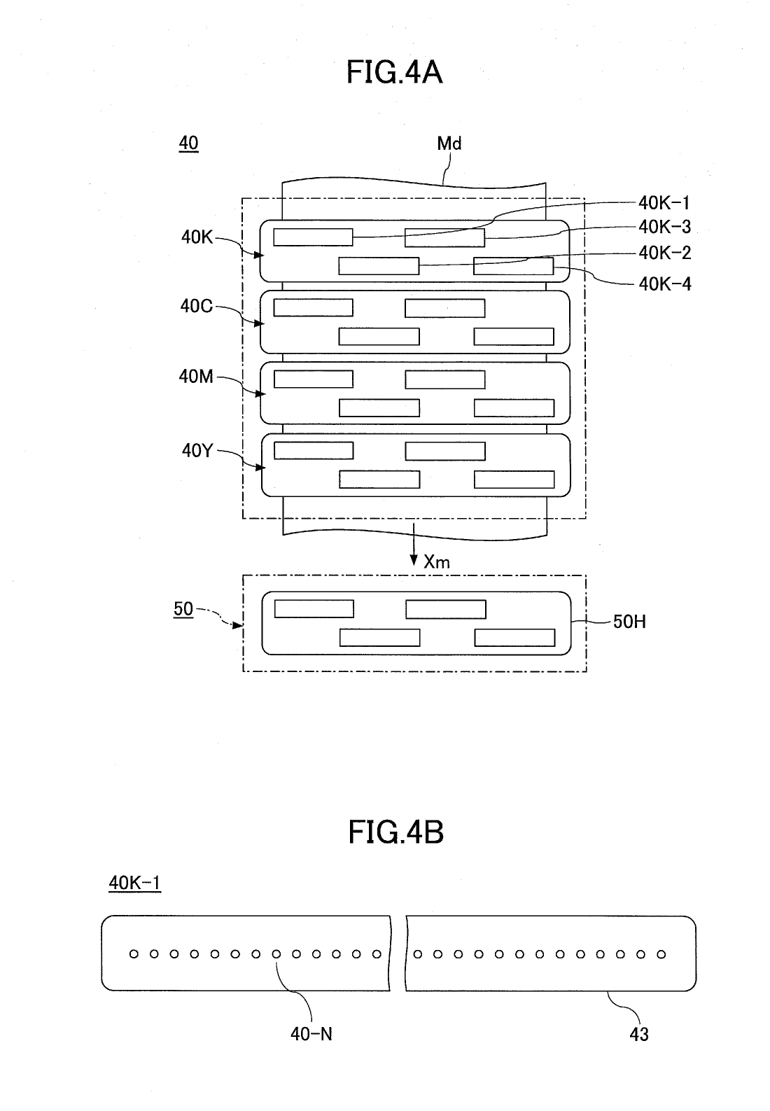

An example of the external structure of the image forming unit 40 will be described with reference to FIG. 4. FIG. 4A is a general plan view of an example of the overall configuration of the image forming unit 40 of the image forming apparatus 100 according to the present embodiment. FIG. 4B is a diagram illustrating an enlarged plan view of an example of a core part (discharge head 40K of black ink (K)) of the image forming unit 40.

As shown in FIG. 4A, the image forming unit 40 may use a full-line-type head according to the present embodiment. Namely, in the image forming unit 40, four discharge heads 40K, 40C, 40M and 40Y, which deal with black ink (K), cyan ink (C), magenta ink (M) and yellow ink (Y), respectively, are arranged starting from the upstream side in the conveyance direction Xm of the recording medium.

The discharge unit 40K for black ink (K) according to the present embodiment includes four head units 40K-1, 40K-2, 40K-3 and 40K-4, arranged in a staggered manner in the direction orthogonal to the conveyance direction Xm of the rolled paper Md. Accordingly, the image forming unit 40 can form an image on the entire area in the width direction (orthogonal to the conveyance direction) of the image forming region (print region) of the rolled paper Md (recording medium). The other discharge heads 40C, 40M and 40Y have the same configuration as the discharge head 40K for black ink (K), and the description is omitted.

FIG. 4B illustrates the enlarged plan view of the head unit 40K-1 of the discharge head 40K of black ink (K) of the image forming unit 40.

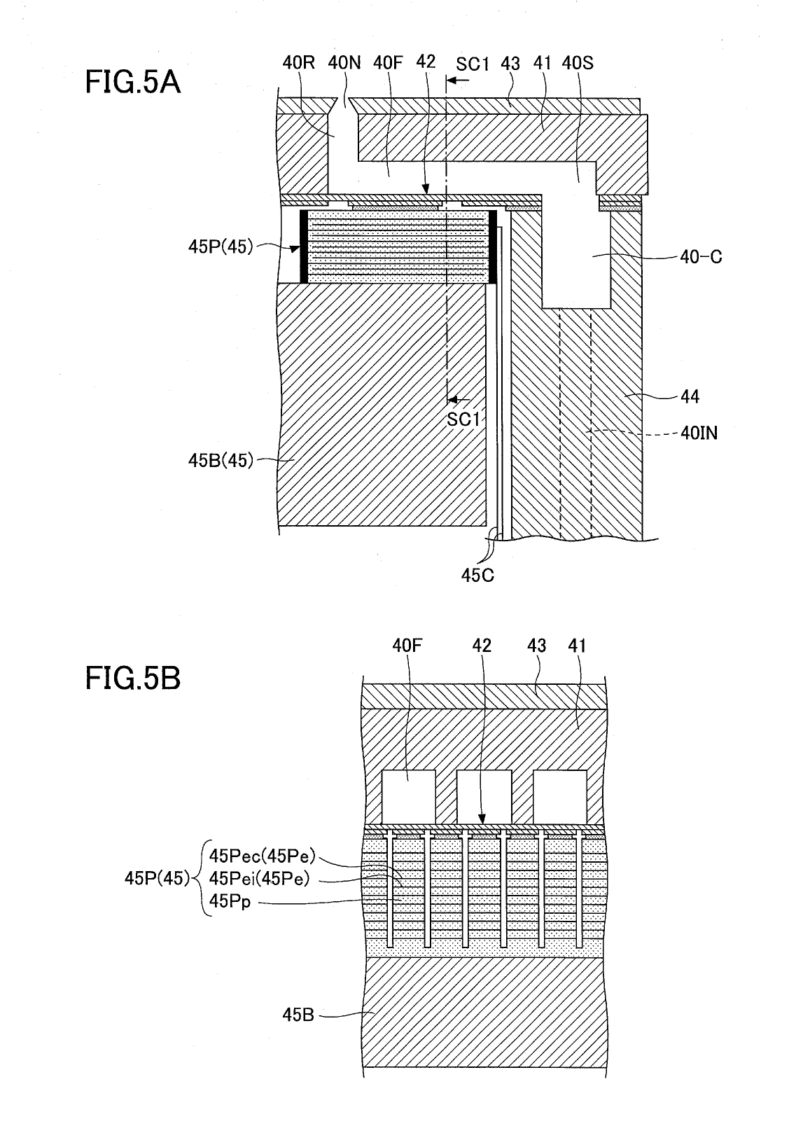

As shown in FIG. 4B, the head unit 40K-1 includes multiple discharge openings (nozzles or print nozzles) 40N on its nozzle face (outer surface of a nozzle plate 43 in FIG. 5A, which will be described later) according to the present embodiment. The multiple nozzle ports 40N are arranged in a line in the longitudinal direction of the head unit 40K-1 to form a nozzle array. Note that the head unit 40K-1 may include multiple nozzle arrays.

A cross-sectional shape of the discharge head of the image forming unit 40 will be described with reference to FIGS. 5A-5B. FIG. 5A illustrates a general cross-sectional view of an example of a flow channel (cross section in the longitudinal direction of a liquid chamber 40F). FIG. 5B illustrates a cross-sectional view of an arrangement of the discharge openings 40N of the image forming unit 40, which is a cross section taken along a line SC1 in FIG. 5A in the lateral direction of the liquid chamber 40F (the arrangement direction of the discharge openings).

As shown in FIG. 5A, the discharge head 40K (40C, 40M or 40Y) includes a flow channel plate 41 to form a channel for ink to be discharged, and a vibration plate 42 bonded with the lower surface of the flow channel plate 41 (inward surface in the discharge head 40K). The discharge head 40K (40C, 40M or 40Y) also includes the nozzle plate 43 bonded with the upper surface of the flow channel plate 41 (outward from the discharge head 40K), and a frame member 44 to hold a peripheral part of the vibration plate 42. The discharge head 40K also includes a pressure generation unit (actuator unit) 45 to deform the vibration plate 42.

By stacking the flow channel plate 41, the vibration plate 42 and the nozzle plate 43, a nozzle communication channel 40-R and the liquid chamber 40F can be formed as a passage of ink communicating with the discharge openings 40N (nozzles) in the discharge head 40K (40C, 40M or 40Y) according to the present embodiment. By further stacking the frame member 44, an ink inlet 40S to supply ink to the liquid chamber 40F, and a common liquid chamber 40C to store ink to be supplied to the liquid chamber 40F can be formed in the discharge head 40K (40C, 40M or 40Y).

Furthermore, the discharge head 40K can deform (deform by deflection) the vibration plate 42 by using the pressure generation unit 45. Accordingly, the discharge head 40K can change the volume of the liquid chamber 40F to change pressure applied to ink in the liquid chamber 40F. As a result, the discharge head 40K can discharge ink from the discharge opening 40N.

The flow channel plate 41 may be formed of a single-crystal silicon substrate having a crystal orientation (110). By applying anisotropic etching to the flow channel plate 41 using an alkaline etching liquid such as potassium hydroxide aqueous solution (KOH), a concave portion and a hole portion can be made to form the nozzle communication channel 40-R and the liquid chamber 40F. Note that the material used for the flow channel plate 41 is not limited to a single-crystal silicon substrate. Namely, a stainless steel substrate, photo-sensitive resin, and other materials may be used for the flow channel plate 41.

The vibration plate 42 may be formed of a metal plate of nickel. Accordingly, the vibration plate 42 can be processed by nickel electroforming. Note that the vibration plate 42 may be formed of a metal plate other than made of nickel, or a bonded material of metal and resin.

The nozzle plate 43 may be formed of a single-crystal silicon substrate. Accordingly, the nozzle plate 43 can be processed using the anisotropic etching, similarly to the flow channel plate 41. Note that the nozzle plate 43 may have a water-repellent layer formed on the outer surface made of a metallic member with a required inbetween layer.

The nozzle plate 43 also includes multiple nozzles 40N for discharging droplets (ink drops) according to the present embodiment. Specifically, the nozzle plate 43 has the nozzles 40N formed that have diameters of 10 to 30 μm corresponding to the respective liquid chambers 40F.

The frame member 44 may be formed of a thermosetting resin (for example, an epoxy resin) or polyphenylene sulfite (PPS). Accordingly, the frame member 44 can be processed by injection molding.

Other parts are also formed in the frame member 44 that include an accommodation part to accommodate the pressure generation unit 45, a concave part to form the common liquid chamber 40C, and an ink supply outlet 401N to supply ink to the common liquid chamber 40C from the outside of the discharge head 40K, according to the present embodiment.

Electromechanical transducers can be used for the pressure generation unit 45. The pressure generation unit 45 includes piezoelectric elements 45P as electromechanical transducers, a base substrate 45B to bond and fix the piezoelectric elements 45P, and prop members arranged in gaps between the neighboring piezoelectric elements 45P, according to the present embodiment. The pressure generation unit 45 also includes an FPC (flexible printed circuit) cable 45C to connect the piezoelectric elements 45P with a driver circuit (driver IC) (not shown).

Note that a stacked piezoelectric transducer (PZT) may be used for the piezoelectric element 45P as shown in FIG. 5B in which a piezoelectric material 45Pp and an internal electrode 45Pe are alternately stacked.

The internal electrode 45Pe includes multiple individual electrodes 45Pei and multiple common electrodes 45Pec. The internal electrode 45Pe has the individual electrodes 45Pei and the common electrodes 45Pec alternately connected with the end surfaces of the piezoelectric material 45Pp, according to the present embodiment.

Also, the piezoelectric element 45P uses a d33 direction as the piezoelectric direction of the piezoelectric material 45Pp, according to the present embodiment. Accordingly, the pressure generation unit 45 can increase or decrease the pressure applied to the ink in the liquid chamber 40F, using the piezoelectric effect of the piezoelectric element 45P (displacement in the d33 direction). Note that the pressure generation unit 45 may increase or decrease the pressure applied to the ink in the liquid chamber 40F, by using a displacement in a d31 direction. Also, the pressure generation unit 45 may have a line of piezoelectric elements 45P arranged for one discharge opening 40N.

Note that the prop members may be formed at the same time as the piezoelectric elements 45P, by dividing the piezoelectric element member into multiple piezoelectric elements 45P. Namely, the discharge head 40K can use the piezoelectric element members as the prop members by not applying voltage to the piezoelectric elements 45P.

In the following, operations of discharging ink (pull-push discharge operations) from the nozzle 40N by the discharge head 40K will be specifically described.

The discharge head 40K first lowers a voltage applied to the piezoelectric element 45P (pressure generation unit 45) from a reference potential to contract the piezoelectric element 45P in the stacked direction, according to the present embodiment. The discharge head 40K also deforms the vibration plate 42 by deflection caused with the contraction of the piezoelectric element 45P. At this moment, the discharge head 40K enlarges (expands) the volume of the liquid chamber 40F by the deflected deformation of the vibration plate 42. Accordingly, the discharge head 40K can make ink flow into the liquid chamber 40F from the common liquid chamber 40C.

Next, the discharge head 40K raises the voltage applied to the piezoelectric element 45P to extend the piezoelectric element 45P in the stacked direction. The discharge head 40K also deforms the vibration plate 42 toward the nozzle 40N by the extension of the piezoelectric element 45P. At this moment, the discharge head reduces (contracts) the volume of the liquid chamber 40F by the deformation of the vibration plate 42. Accordingly, the discharge head 40K can apply pressure to the ink in the liquid chamber 40F. By applying pressure to the ink, the discharge head 40K can discharge (jet out) the ink from the discharge opening 40N.

Then, the discharge head 40K returns the voltage applied to the piezoelectric element 45P back to the reference potential, and returns (restores) the vibration plate 42 back to the initial position. At this moment, the discharge head 40K lowers the pressure in the liquid chamber 40F by the expansion of the liquid chamber 40F, and fills the liquid chamber 40F with ink from the common liquid chamber 40C. Next, after a vibration of the meniscus face of the nozzle 40N has been damped (stabilized), the discharge head 40K proceeds to operations of discharging ink for the next time, and repeats the above operations.

Note that the drive method of the discharge head 40K that can be used is not limited to the above example (pull-push discharge operations). Namely, the drive method of the discharge head 40K may include an operation of pull-discharge or push-discharge by controlling the voltage (drive waveform) applied to the piezoelectric element 45P.

Thus, the image forming apparatus 100 according to the present embodiment can form a monochrome or full color image on the entire area of the image forming region by a single conveyance operation of the recording medium (rolled paper Md), using the image forming unit 40 (four discharge heads 40K, 40C, 40M and 40Y).

Note that the pressure generation unit 45 that can be used in the present embodiment is not limited to the above example (piezoelectric element 45P). Namely, the pressure generation unit 45 may adopt a method of heating ink in the liquid chamber 40F to generate air bubbles (what is called a “thermal type”, see Japanese Laid-open Patent Publication No. S61-59911, for example). Also, the pressure generation unit 45 may adopt a method of deforming the vibration plate by an electrostatic force between the vibration plate and an electrode disposed on the walls of the liquid chamber 40F to face each other (what is called a “electrostatic type”, see Japanese Laid-open Patent Publication No. H06-71882, for example).

1-5. Configuration of Postprocess Unit

The postprocess unit 50 is a unit to perform a process for the recording medium having an image formed. The postprocess unit 50 applies a postprocess liquid to the recording medium with the amount of the postprocess liquid that is determined based on at least the image forming speed. The postprocess unit 50 performs the postprocess by applying the postprocess liquid to the surface of the rolled paper Md having an image formed by the image forming unit 40, according to the present embodiment. As shown in FIG. 4A, the postprocess unit 50 is arranged on the downstream side of the image forming unit 40 in the conveyance direction Xm of the recording medium. Also, similarly to the image forming unit 40, the postprocess unit 50 has discharge heads 50H (dischargers) arranged in a staggered manner in the direction perpendicular to the conveyance direction Xm of the rolled paper Md. Furthermore, the postprocess unit 50 controls a drive waveform input into the discharge heads 50H to control the discharge amount of the postprocess liquid. Accordingly, using the discharge heads 50H, the postprocess unit 50 can discharge the postprocess liquid onto the entire area of the image forming region (print region) of the rolled paper Md (recording medium) in the width direction (perpendicular to the conveyance direction). Note that the configuration of the discharge head 50H is substantially the same as that of the image forming unit 40 (FIGS. 4A to 5B), and the description is omitted.

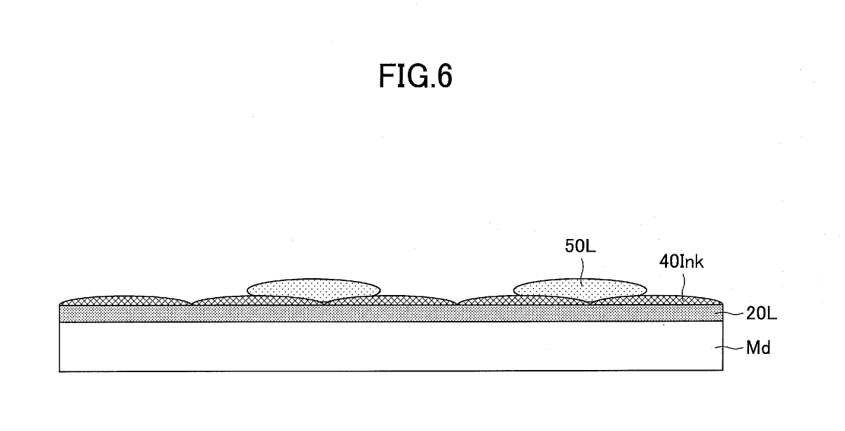

The postprocess here is a process of discharging (depositing) the postprocess liquid, which will be described later, onto the rolled paper Md (recording medium). The postprocess liquid is applied in a shape including spots or stripes. This improves the recording medium having an image formed in terms of rub resistance, glossiness, preservation stability (water-repellency, light resistance, and gas resistance), and the like. For example, as shown in FIG. 6, when starting the postprocess by the postprocess unit 50, the surface of the rolled paper Md (product) has the preprocess liquid 20L applied, and further has the ink 40Ink discharged onto it to have an image formed. The postprocess unit 50 of the image forming unit 100 according to the present embodiment performs the process to discharge (deposit) the postprocess liquid 50L onto the rolled paper Md having the image formed, as the postprocess.

Furthermore, the postprocess unit 50 of the image forming unit 100 according to the present embodiment may discharge the postprocess liquid onto an area smaller than the surface area of the recording medium where the preprocess liquid has been applied. Also, the postprocess unit 50 may discharge the postprocess liquid onto the area smaller than the surface area where the preprocess liquid has been applied, at least in a part where the image has been formed on the recording medium.

Note that the postprocess liquid 50L is discharged (deposited) onto an area at least smaller than that has been applied with the preprocess liquid 20L. Also, the cross-sectional view shows that the ink 40Ink has been discharged onto the entire area, and the postprocess liquid 50L is discharged (deposited) onto a smaller area.

Note that although the postprocess liquid 50L seems to be discharged in spots in FIG. 6, it may be discharged in stripes perpendicular to the cross-section.

As shown in FIG. 6, the postprocess liquid 50L may be discharged (deposited) onto an area smaller than the surface area on which the image has been formed, at least onto the part where the image has been formed on the recording medium. Also, the postprocess liquid 50L may or may not be discharged (deposited) onto the area where the image has not been formed.

Note that if the recording medium having the shape shown in FIG. 6 is abraded by another medium, a surface part of the layer of the postprocess liquid 50L is abraded. Due to the height of the layer of the postprocess liquid 50L, the image (ink 40Ink) can be prevented from being peeled by the abrasion not only in a part where the postprocess liquid 50L has been deposited but also in a part where the postprocess liquid 50L has not been deposited.

Thus, the image forming apparatus 100 according to the present invention can deposit (discharge) the postprocess liquid 50L onto the recording medium (rolled paper Md) having an image formed, using the postprocess unit 50. Accordingly, compared with a case where the postprocess liquid is not deposited, the image forming apparatus 100 can avoid peeling of an image (ink) on the recording medium when the surface of the recording medium (rolled paper Md) having the image formed is abraded with another object (for example, another recording medium). Namely, the image forming apparatus 100 according to the present embodiment can improve rub resistance (abrasion resistance) of an image formed on the recording medium by using the postprocess unit 50.

Also, the image forming apparatus 100 according to the present embodiment can deposit (discharge) the postprocess liquid 50L onto the recording medium (rolled paper Md) having an image formed by using the postprocess unit 50, to improve the quality of the image formed on the recording medium. Namely, the image forming apparatus 100 can deposit the postprocess liquid 50L on the recording medium on which an image is formed by using the postprocess unit 50, which reduces occurrences of quality problems of the formed image relating to blurring, density, color tone, and strike through, as well as other problems relating to durability of the images, such as water-repellency and weatherability.

It is preferable to have the postprocess unit 50 of the image forming apparatus 100 according to the present embodiment deposit (discharge) the postprocess liquid 50L only on a specific part within the region where an image has been formed on the rolled paper Md, as the postprocess method. It is further preferable to have the postprocess unit 50 change the discharge amount (application amount) and the method of discharge (application) of the postprocess liquid 50L based on the type, permeability, glossiness and/or resolution of the recording medium, and/or the application amount (liquid amount) of the preprocess liquid 20L that has been applied by the preprocess unit 20.

Also, using the discharge head, the postprocess unit 50 according to the present embodiment can discharge the postprocess liquid 50L onto an arbitrary area (arbitrary location) with a desired amount (on desired spots or desired stripes).

Specifically, the postprocess unit 50 can select an area to be discharged from one of (1) the entire area where an image can be formed on the rolled paper Md (recording medium); (2) an area where the image has been formed; and (3) only a part of the area where the image has been formed (dot-discharged part). The postprocess unit 50 may also select another option; (4) an area larger than the part where the image has been formed, by one or more dots outward from the outer edge of the part on the rolled paper Md (recording medium). Furthermore, the postprocess unit 50 can discharge the postprocess liquid 50L onto no of the area (spots or stripes) selected to be discharged with the postprocess liquid.

The value of n may be arbitrarily selected within a range of 5 to 50. Also, the value of n may be determined experimentally or by numerical calculations in advance.

The postprocess unit 50 according to the present embodiment can also select the method of discharging the postprocess liquid 50L from one of (1) discharging based on a print duty; and (2) discharging based on an amount of droplets of the postprocess liquid 50L to be discharged, or the like. Also, the postprocess unit 50 may calculate the print duty and the amount of droplets of the postprocess liquid 50L from input information such as print image data, and then, may determine the method of discharging based on the calculated print duty and the like.

Furthermore, the postprocess unit 50 may select the application area from one of (1) the entire area where an image can be formed; (2) the preprocess liquid application area; (3) an area smaller than the entire area but greater than the preprocess liquid application area; (4) only the image forming area; and (5) an area smaller than the image forming area. In any of these cases, the postprocess unit 50 applies the postprocess liquid 50L on the application area based on a determined application amount (application rate) so that the postprocess liquid 50L is applied to at least the image formed area by the predetermined rate to protect the formed image.

Also, the postprocess unit 50 in the present embodiment may select the application area of the postprocess liquid 50L by taking image data into account. The postprocess unit 50 in the present embodiment may preferably select (1) the entire area where an image can be formed, for example, for a solid image, or (3) only the image forming area for image data having a wide margin. Also, the postprocess unit 50 may select the area, for example, based on the print duty (print rate) or the amount of discharged ink. Furthermore, the postprocess unit 50 may be configured to generate a database beforehand that stores, for example, the above data so that it may calculate the print duty (print rate) or the amount of ink from input information, namely, image data, and refer to the database by the calculated result to determine the application range of the postprocess liquid 50L.

Accordingly, compared with a case of applying (discharging) the postprocess liquid 50L on the whole surface of the recording medium, the image forming apparatus 100 according to the present embodiment can deposit (discharge) the postprocess liquid 50L only onto the specific part within the area where the image has been formed, by using the postprocess unit 50. Therefore, the image forming apparatus 100 according to the present embodiment can shorten the time required for the postprocess, especially for drying the postprocess liquid 50L. Also compared with a case of applying (discharging) the postprocess liquid 50L on the whole surface of the recording medium, the image forming apparatus 100 according to the present embodiment can reduce the amount of the postprocess liquid 50L required for the postprocess. Furthermore, compared with a case of applying (discharging) the postprocess liquid 50L on the whole surface of the recording medium, the image forming apparatus 100 according to the present embodiment can reduce the amount of the postprocess liquid 50L and the cost required for the postprocess.

Also, the postprocess unit 50 of the image forming apparatus 100 according to the present embodiment can control the discharge amount of the postprocess liquid 50L based on the image forming speed (recording speed) of an image, and hence, can reduced the postprocess liquid amount when the image forming speed is low. Namely, the postprocess unit 50 according to the present embodiment can reduce the postprocess liquid amount when the image forming speed is low, and hence, can reduce the cost relating to image forming. Also, the postprocess unit 50 according to the present embodiment can increase the postprocess liquid amount when the image forming speed becomes higher, and hence, can maintain sufficient abrasion resistance and durability of the image when the image forming speed is high.

Furthermore, the postprocess unit 50 of the image forming apparatus 100 according to the present embodiment may control the discharge amount of the postprocess liquid 50L by further using the type of the recording medium, to reduce the postprocess liquid amount when the recording medium has low permeability and the image forming speed is low, and to reduce the cost. Also, the postprocess unit 50 may control the discharge amount of the postprocess liquid 50L by further using the resolution of an image to be formed and the type of ink to form the image, to reduce the postprocess liquid amount when the recording medium has low permeability and the image forming speed is low, and to reduce the cost.

Note that the method of performing the postprocess by the postprocess unit 50 has no specific restrictions, and may be appropriately selected depending on the type of the postprocess liquid. Also, the method of postprocessing by the postprocess unit 50 may use the above-described method of applying the preprocess liquid by the preprocess unit 20, or the above-described method of discharging ink by the image forming unit 40. Furthermore, it is preferable that the method of postprocessing by the postprocess unit 50 uses the same method as the method of discharging ink by the image forming unit 40 in view of downsizing of the apparatus and preservation stability of the postprocess liquid. When discharging the postprocess liquid, it is preferable to include an appropriate amount of water-soluble organic solvent (wetting agent) that is used in the method of discharging ink by the image forming unit 40.

Also, it is preferable to obtain the dried adherence amount of the postprocess liquid 50L in the range of 0.5 g/m² to 10 g/m² by the postprocess unit 50 according to the present embodiment. It is more preferable to obtain the dried adherence amount of the postprocess liquid 50L in the range of 2 g/m² to 8 g/m² by the postprocess unit 50. When the dried adherence amount of the postprocess liquid 50L is less than 0.5 g/m², the quality of the image (rub resistance, image density, chromaticity, glossiness and fixing) may be degraded. Also, when the dried adherence amount of the postprocess liquid 50L is greater than 10 g/m², the drying characteristic of the protection layer (postprocess liquid) may be degraded (the drying may take a long time). Furthermore, when the dried adherence amount of the postprocess liquid is greater than 10 g/m², improvement of the image quality by the postprocess may be saturated, and may be economical disadvantage.

The postprocess unit 50 according to the present embodiment may use, as the postprocess liquid 50L, a process liquid including ingredients that can form a transparent protection layer on the rolled paper Md (recording medium). The process liquid including ingredients that can form a transparent protection layer are, for example, a process liquid including a water dispersible resin (resin), a water-soluble organic agent (wetting agent), a penetrating agent, surfactant, water, and/or other ingredients when necessary. Also, the postprocess liquid 50L may be a resin composition including an ingredient polymerized by ultraviolet irradiation, and/or a thermoplastic resin. Furthermore, the postprocess liquid 50L is preferably a thermoplastic resin emulsion for improving the glossiness and the fixing. Accordingly, the postprocess unit 50 can increase the glossiness of the surface of the rolled paper Md having an image formed, or can protect the surface of the rolled paper Md with a resin layer, in accordance with the method of discharge (application).

Note that the water dispersible resin (resin) is preferably, for example, an acrylic resin, a styrene-acrylic resin, a urethane resin, an acrylic-silicone resin, a fluorine resin, or the like. Among these water dispersible resins, the same resin as the water dispersible resin used in the method of discharging ink by the image forming unit 40 may be arbitrarily selected and used. Also, content of the water dispersible resin in the protection layer is preferably within a range of 1 mass % to 50 mass % in solid. Furthermore, when using the method of discharging ink by the image forming unit 40, the content of the water dispersible resin in the protection layer is preferably within a range of 1 mass % to 30 mass %.

When the content of resin exceeds 50 mass %, viscosity of the postprocess liquid may be high. Also, when the content of resin is less than 1 mass %, required energy may increase for evaporating water in the postprocess liquid 50L.

A mean particle diameter (D50) of the water dispersible resin in the postprocess liquid 50L relates to the viscosity of the postprocess liquid 50L. When the compositions are the same, the smaller the particle diameter is, the higher the viscosity of the postprocess liquid 50L is. Therefore, to avoid excessively high viscosity for the postprocess, the mean particle diameter (D50) of the water dispersible resin is preferably greater than or equal to 50 nm.

Also, it is not preferable that the mean particle diameter of the water dispersible resin in the postprocess liquid 50L is several tens of micrometers because it is greater than the nozzle diameter of the discharge head (the diameter of the discharge opening 40N in FIG. 4A) used for discharging the postprocess liquid 50L. Also, even if the mean particle diameter of the water dispersible resin in the postprocess liquid 50L is less than the nozzle diameter, the discharging performance of the discharge head may be degraded as long as there are particles having greater diameters.

Therefore, the mean particle diameter (D50) of the postprocess liquid (water dispersible resin) is preferably less than or equal to 200 nm, and more preferably less than or equal to 150 nm.

When using the water-soluble organic agent (wetting agent), the content of the water-soluble organic agent in the postprocess liquid 50L has no specific restrictions. The content of the water-soluble organic agent may be within a range of 10 to 80 mass %. The content of the water-soluble organic agent is preferably within a range of 15 to 60 mass %. The water-soluble organic agent (wetting agent) is, for example, 1, 3-butadiene or glycerin.

Note that if the content of the water soluble organic agent is larger than 80 mass %, the recording medium having the postprocess applied may become harder to dry. Also, if the content of the water soluble organic agent is less than 10 mass %, the composition of the postprocess liquid 50L may change when mixed with the preprocess liquid 20L.

The penetrating agent and the surfactant have no specific restrictions. The penetrating agent is, for example, 2-ethyl-1, 3-hexanediol. The surfactant is, for example, perfluoroalkyl polyethylene oxide adduct. The penetrating agent and the surfactant may be arbitrarily selected among the penetrating agent and the surfactant included in the preprocess liquid 20L used by the preprocess unit 20 or in the ink used by the image forming unit 40.

Note that the postprocess liquid 50L may further include other ingredients. The postprocess liquid 50L may further include, for example, wax, a pH adjuster, an antimicrobial agent, a surface modifier, and an antifoam agent.

The wax is, for example, polyethylene wax. The pH adjuster is, for example, 2-amino-2-ethyl-1, 3-propanediol. The antimicrobial agent contains, for example, 1,2-benzothiazole-3-one as an active ingredient. The surface modifier is, for example, a mixture of polyether-modified polydimethylsiloxane and polyether (polyether-modified polydimethylsiloxane). The antifoam agent is, for example, 2, 4, 7, 9-tetramethyl-4, 7-decanediol.

1-6. Configuration of Take-Out Unit

The take-out unit 60 takes out (discharges) a recording medium having an image formed. As shown in FIG. 1, the take-out unit 60 is configured with a storage unit 61 and multiple conveyance rollers 62 according to the present embodiment. Using the conveyance rollers 62, the take-out unit 60 winds the rolled paper Md having an image formed around a storage roll of the storage unit 61 to store it.

Note that if pressure acting on the rolled paper Md is high when the rolled paper Md is being wound around the storage roll of the storage unit 61, a drying unit may be provided to prevent images from transferring to the back side of the rolled paper Md, and used just before the wind-up.

1-7. Configuration of Control Unit

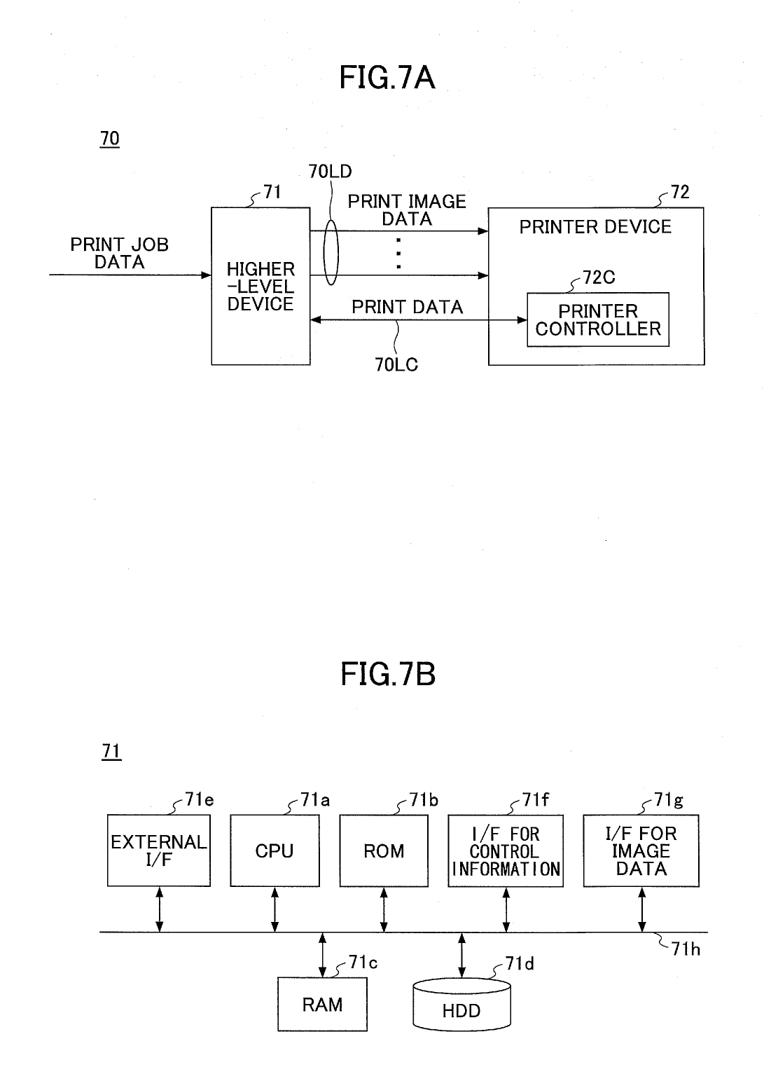

The control unit 70 controls operations of the image forming apparatus 100. The control unit 70 issues operation commands to the elements of the image forming apparatus 100 to control the operations. With reference to FIGS. 7A-10, the control unit 70 according to the present embodiment will be described.

Note that the image forming apparatus 100 may use production printing as a printing system. The production printing here is a manufacturing system that can perform printing (forming images or printing characters) for a considerable amount of printed matter (image formed media or character printed matter) by efficiently performing job management and print data management. Specifically, the image forming apparatus 100 according to the present embodiment includes multiple devices, for example, a RIP (Raster Image Processor) and a printer device. The RIP (Raster Image Processor) controls print order of print data and converts the print data to raster image data. The printer device controls print operations based on the converted raster image data.

Also, the image forming apparatus 100 (control unit 70) according to the present embodiment constitutes a workflow management system for operations covering from print data creation up to printed matter distribution. Namely, the image forming apparatus 100 (control unit 70) according to the present embodiment can speed up printing of a time-consuming workflow, by distributing processes into separate devices such as the RIP (Raster Image Processor) and the printer device.

As shown in FIG. 7A, the control unit 70 of the image forming apparatus 100 according to the present embodiment includes a higher-level device (RIP or Digital Front End (DFE)) 71 to perform a RIP process, and a printer device 72 to perform a print process. The higher-level device 71 and the printer device 72 are connected with each other via multiple data lines 70LD and a control line 70LC.

In the following, the higher-level device 71 and the printer device 72 will be specifically described.

[Higher-Level Device]

The higher-level device 71 of the control unit 70 of the image forming apparatus 100 according to the present embodiment performs the RIP process based on print job data (job data or print data) output from a host apparatus (not shown). Namely, the higher-level device 71 creates raster image data corresponding to each color (referred to as “print image data” below), based on the print job data. The print job data further includes data relating to the discharge of the postprocess liquid 50L discharged by the postprocess unit 50 (referred to as “image data relating to the postprocess” below) according to the present embodiment.

Also, the higher-level device 71 according to the present embodiment creates data for controlling print operations (referred to as “control data” below), based on the print job data and information about the host apparatus. The control data here includes data relating to print conditions (print form, print type, information about feeding or ejecting paper, order of print sides, size of print paper, data size of print image data, resolution, information about type of paper, gradation, color information, number of pages to be printed, and the like). Also, the control data further includes data relating to the discharge of the postprocess liquid 50L discharged by the postprocess unit 50 (referred to as “control data relating to the postprocess” below) according to the present embodiment.

As shown in FIG. 7B, the higher-level device 71 according to the present embodiment includes a CPU (Central Processing Unit) 71a, a ROM (Read-Only Memory) 71b, a RAM (Random Access Memory) 71c and an HDD (Hard Disk Drive) 71d. The higher-level device 71 also includes an external I/F 71e, an I/F for control information 71f and an I/F for image data 71g. The higher-level device 71 further includes a bus 71h that connects the CPU 71a and the like with each other. Namely, the higher-level device 71 has a configuration in which the CPU 71a and the like are connected via the bus 71h to communicate with each other.

The CPU 71a controls operations of the higher-level device 71 as a whole. The CPU 71a controls the operations of the higher-level device 71 by using a control program or the like stored in the ROM 71b and/or the HDD 71d.

The ROM 71b, the RAM 71c and the HDD 71d store data and the like. The ROM 71b and/or the HDD 71d stores the control program for controlling the CPU 71a in advance. The RAM 71c is used as a work memory for the CPU 71a.

The external I/F 71e controls communication (transmission and reception) to/from the outside of the image forming apparatus 100, such as the host apparatus. The external I/F 71e can control, for example, the communication by TCP/IP (Transmission Control Protocol/Internet Protocol).

The I/F for control information 71f controls communication (transmission and reception) of control data. The I/F for control information 71f may use, for example, PCI Express (Peripheral Component Interconnect Bus Express).

The I/F for image data 71g controls communication (transmission and reception) of print image data. The I/F for image data 71g may use, for example, PCI Express. The I/F for image data 71g has multiple channels corresponding to colors of the print image data according to the present embodiment, as will be described later.

The higher-level device 71 of the control unit 70 according to the present embodiment receives print job data sent from the host apparatus at the external I/F 71e, and stores the data in the HDD 71d using the CPU 71a. Also, the higher-level device 71 reads out the print job data from the HDD 71d using the CPU 71a. Based on the read-out print job data, the higher-level device 71 further creates raster image data of the respective colors (yellow (Y), cyan (C), magenta (M) and black (K)), and stores the created raster image data of the respective colors in the RAM 71c, using the CPU 71a. Note that the higher-level device 71 (CPU 71a) may create the raster image data of the respective colors to be written in the RAM 71c by, for example, rendering the PDL (Page Description Language) as the RIP process.

Next, the higher-level device 71 compresses and encodes the raster image data of the respective colors that has been written in the RAM 71c, and temporarily stores the data in the HDD 71d.

Afterward, when the printer device 72 starts print operations, the higher-level device 71 (CPU 71a) reads out the encoded raster image data of the respective colors from the HDD 71d, decodes the data, and writes the decoded raster image data of the respective colors in the RAM 71c. Next, the higher-level device 71 reads out the raster image data of the respective colors from the RAM 71c, and outputs the data as the print image data of the respective colors to the printer device 72 (printer engine 72E, which will be described later) via the respective channels of the I/F for image data 71g. Note that the higher-level device 71 may output the print image data to the printer device 72 via the data lines 70LD (70LD-Y, 70LD-C, 70LD-M and 70LD-K) shown in FIG. 7A as the respective channels of the I/F for image data 71g.

Depending on progress of the print operations and the like, the higher-level device 71 according to the present embodiment also transmits/receives the control data to/from the printer device 72 (printer controller 72C, which will be described later) via the I/F for control information 71f (control line 70LC), using the CPU 71a.

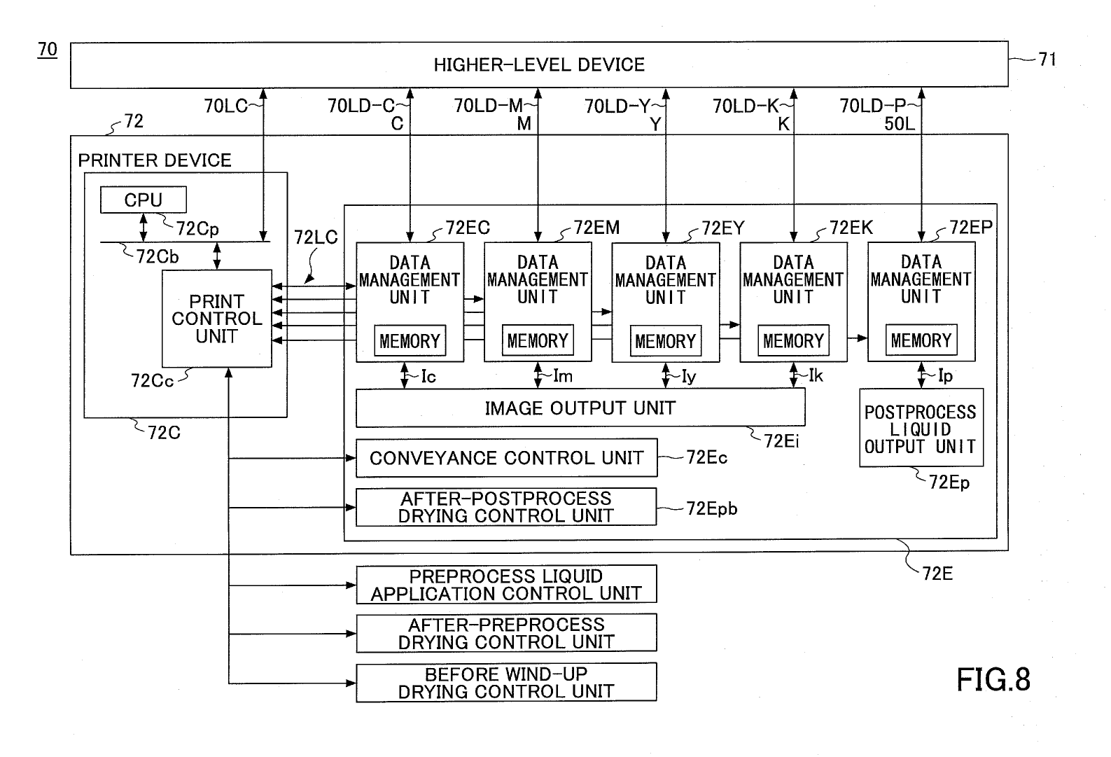

Furthermore, when the printer device 72 (postprocess unit 50 in FIG. 1) starts the postprocess, the higher-level device 71 according to the present embodiment reads out the encoded image data relating to the postprocess from the HDD 71d, and outputs the data to the printer device 72 (printer engine 72E) via the data line 70LD-P (FIG. 8), in the same way as done with the above raster image data, using the CPU 71a.

[Printer Device]

The printer device 72 of the control unit 70 of the image forming apparatus 100 according to the present embodiment controls operations of forming an image on a recording medium, based on print image data and control data input from the higher-level device 71. The printer device 72 includes the printer controller 72C and the printer engine 72E according to the present embodiment.

The printer controller 72C controls operations of the printer engine 72E as will be described later. The printer controller 72C transmits/receives control data and the like to/from the higher-level device 71 via the control line 70LC. Also, the printer controller 72C transmits/receives the control data and the like to/from the printer engine 72E via the control line 72LC. Configured as above, the printer controller 72C can write various print conditions included in the control data into a register in a print control unit 72Cc to store the print conditions. Also, the printer controller 72C can control the printer engine 72E based on the control data to execute printing in accordance with the print job data (control data).

As shown in FIG. 8, the printer controller 72C includes a CPU 72Cp and the print control unit 72Cc according to the present embodiment. Also, the printer controller 72C has the CPU 72Cp and the print control unit 72Cc connected with each other via a bus 72Cb for communication. The bus 72Cb here is connected with the control line 70LC via a communication I/F (not shown).

The CPU 72Cp controls operations of the printer device 72 as a whole using a control program stored in a ROM (not shown). The print control unit 72Cc transmits/receives a command or status information to/from the printer engine 72E, based on the control data transmitted from the higher-level device 71. Thus, the print control unit 72Cc can control the operations of the printer engine 72E.

The printer engine 72E is a device to control operations of forming an image on a recording medium based on the print image data input from the higher-level device 71 and the control data input from the printer controller 72C. Also, the printer engine 72E is a device to control operations of the postprocess based on the print image data input from the higher-level device 71 (image data relating to the postprocess) and on the control data input from the printer controller 72C (control data relating to the postprocess).

As shown in FIG. 8, to the printer engine 72E is connected with the multiple data lines 70LD (70LD-Y, 70LD-C, 70LD-M, 70LD-K and 70LD-P). The printer engine 72E receives the print image data from the higher-level device 71 via the multiple data lines 70LD. Thus, the printer engine 72E can perform print operations for the respective colors and the postprocess based on the received print image data.

The printer engine 72E includes multiple data management units 72EC, 72EM, 72EY, 72EK and 72EP according to the present embodiment. Also, the printer engine 72E includes an image output unit 72Ei to receive the print image data and the like as input from the data management unit 72EC or the like, and a conveyance control unit 72EC to control conveyance of a recording medium. The printer engine 72E further includes a postprocess liquid output unit 72Ep to receive the image data relating to postprocess as input from the data management unit 72EP, and an after-postprocess drying control unit 72Epb to control operations of the drying unit 30 (FIG. 1) according to the present embodiment.

The printer engine 72E may further include a preprocess liquid application control unit, an after-preprocess drying control unit, a before-wind-up drying control unit.

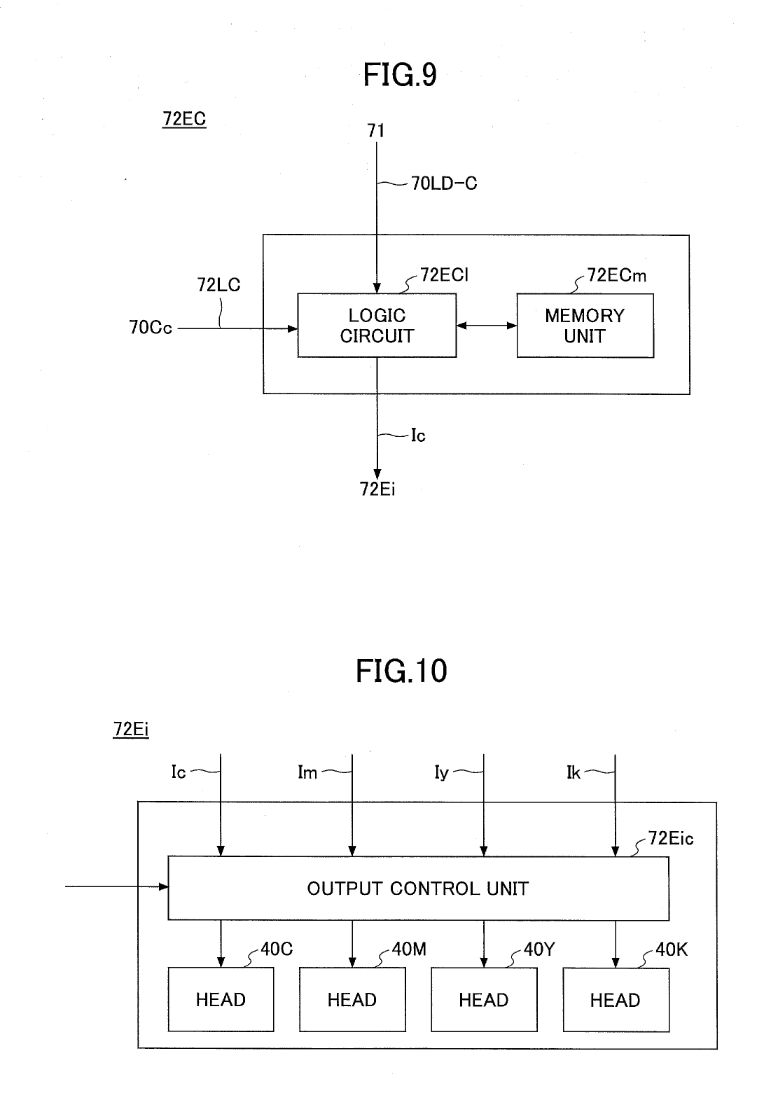

A configuration of the data management unit 72EC will be described with reference to FIG. 9. Note that configurations of the other data management units 72EM, 72EY, 72EK and 72EP are the same as that of the data management unit 72EC, and their description is omitted.

As shown in FIG. 9, the data management unit 72EC includes a logic circuit 72ECl and a memory unit 72ECm. The data management unit 72EC (logic circuit 72ECl) is connected with the higher-level device 71 via the data line 70LD-C. Also, the data management unit 72EC (logic circuit 72ECl) is connected with the printer controller 72C (print control unit 72Cc) via the control line 72LC.

The logic circuit 72ECl stores print image data output from the higher-level device 71 in the memory 72ECm based on a control signal output from the printer controller 72C (print control unit 72Cc) according to the present embodiment. Also, the logic circuit 72ECl reads out print image data Ic (FIG. 8) corresponding to cyan (C) from the memory 72ECm based on the control signal output from the printer controller 72C (print control unit 72Cc), and outputs the data to the image output unit 72Ei. Note that the logic circuit 72ECp (data management unit 72EP) outputs the image data relating to postprocess Ip (FIG. 8) to the postprocess liquid output unit 72Ep.

Note that the memory unit 72ECm may have a capacity that can store at least three pages of print image data. The three pages of the print image data are, for example, print image data corresponding to a page that is transferred (received) from the higher-level device 71, print image data corresponding to a page which is being output to the image output unit 72Ei, and print image data corresponding to the next page.

Note that the data management unit 72EC may use a hardware logic circuit including a combination of logic circuit elements and the like. Accordingly, the data management unit 72EC can realize a faster process. Also, the data management unit 72EC may perform, for example, a logical determination on the control signal including a bit string using the logic circuit 72ECl to determine a process to execute.

A configuration of the image output unit 72Ei will be described with reference to FIG. 10. Note that a configuration of the postprocess liquid output unit 72Ep is substantially the same as that of the image output unit 72Ei, and its description is omitted.

As shown in FIG. 10, the image output unit 72Ei includes an output control unit 72Eic. The output control unit 72Eic outputs print image data corresponding to respective colors to the discharge heads 40C, 40M, 40Y and 40K (FIG. 4A) corresponding to the respective colors. Thus, the output control unit 72Eic can control the operation of the discharge head 40C based on the print image data.

Specifically, the output control unit 72Eic controls the multiple discharge heads 40C individually. Also, the output control unit 72Eic may control the multiple discharge heads 40C simultaneously using the input print image data (for example, Ic in FIG. 10). Furthermore, the output control unit 72Eic may control the discharge head 40C based on a control signal input from a control device (not shown). The output control unit 72Eic may control the discharge head 40C, for example, based on an input operation by the user.

Thus, the printer device 72 according to the present embodiment inputs the print image data output from the higher-level device 71 into the multiple discharge heads 40C using the data management unit 72EC and the like and the output control unit 72Eic. Note that the printer device 72 may control the print image data of the respective colors independently of each other. Also, the printer device 72 may change the configuration of the printer engine 72E easily depending on the number of colors of the print image data (C, M, Y and K, only K, or the like) or the number of the discharge heads. Namely, the image forming apparatus 100 (printer device 72) according to the present embodiment has advantage in downsizing of the apparatus and in lowering the cost, by installing only necessary data management units 72EC and the like and the discharge heads 40C and the like.

The image forming apparatus 100 (printer device 72) according to the present embodiment can be provided with all the data management units 72EC in the printer engine 72E when performing, for example, full color printing with four colors of C, M, Y and K. Accordingly, the image forming apparatus 100 (printer device 72) can connect the output from the data management unit 72EC to the discharge heads 40C, respectively.

Also, the image forming apparatus 100 (printer device 72) may be provided with only one data management unit 72EK and a discharge head 40K when performing, for example, printing with one color K, when giving priority to the apparatus cost. Accordingly, the image forming apparatus 100 (printer device 72) can connect the output from the data management unit 72EK to the discharge head 40K by using the output control unit 72Eic.

Furthermore, the image forming apparatus 100 (printer device 72) may be provided with one data management unit 72EK and four discharge heads when performing, for example, printing with one color K, when giving priority to the printing speed.

Accordingly, the image forming apparatus 100 (printer device 72) can connect the output from the data management unit 72EK to the respective discharge heads by using the output control unit 72Eic.

In this case, the image forming apparatus 100 (printer device 72) can print the same color (K) overlaid (superposed) multiple times, and can realize the print process (image forming process) four times faster than when forming an image by one discharge head.

### 2. Operations of Image Forming Apparatus

Operations of the image forming apparatus 100 will be described when controlling the preprocess unit 20, the drying unit 30 and the postprocess unit 50 based on image forming speed (recording speed) according to the present embodiment.

2-1. Operations of Preprocess Unit

Based on at least image forming speed, the preprocess unit 20 in the present embodiment (FIG. 1) reacts to change of time until the closest dot is printed (ink droplet is discharged) when forming an image. For example, when the image forming speed is higher, time intervals for discharging dots becomes shorter. Therefore, to avoid generation of blur of ink (beading), the preprocess unit 20 aggregates ink before the closest dot is discharged. Also when the image forming speed is high, the preprocess unit 20 discharges ink droplets, for example, at a high frequency when forming an image. Therefore, the preprocess unit 20 controls the preprocess liquid amount based on the image forming speed to avoid generation of blur of ink (beading), by aggregating the ink before the closest dot of a volume-increased ink droplet is discharged.

Furthermore, when conveyance speed (image forming speed) is high, position accuracy of discharged ink droplets may get worse due to an influence of airflow caused by conveyance of a recording medium, and some image areas may have distances between dots shorter than desired. In this case, the preprocess unit 20 controls the preprocess liquid amount based on the conveyance speed (image forming speed) to avoid generation of blur of ink (beading), by aggregating the ink before the closest dot is discharged.

Thus, by changing the required application amount of the preprocess liquid based on the image forming speed, the preprocess unit 20 can suppress generation of beading to improve the image quality. It is preferable to have the preprocess unit 20 increase the application amount of the preprocess liquid, for example, when the image forming speed is higher. It is also preferable to have the preprocess unit 20 decrease the application amount of the preprocess liquid, for example, when the image forming speed is lower.

2-2. Operations of Postprocess Unit

The postprocess unit 50 in the present embodiment (FIG. 1) controls the application (discharge) amount of the postprocess liquid 50L based on at least the image forming speed (recording speed).

When the image forming speed is low, for example, the postprocess unit 50 increases time between the impact of ink droplets on a recording medium and the application of the postprocess liquid 50L when forming an image. Accordingly, the postprocess unit 50 can improve adhesion of the recording medium and the ink when applying the postprocess liquid 50L, and the image can have sufficient rub resistance (abrasion resistance) even if the discharge amount of the postprocess liquid 50L is small.

It is preferable to have the postprocess unit 50 increase the application amount of the postprocess liquid 50L, for example, when the image forming speed is higher. It is also preferable to have the postprocess unit 50 decrease the application amount of the postprocess liquid 50L, for example, when the image forming speed is lower.

2-3. Operations of Drying Unit

The drying unit 30 in the present embodiment (FIG. 1) controls drying strength based on at least the image forming speed (recording speed). Accordingly, the drying unit 30 can avoid insufficient drying of the preprocess liquid 20L and the postprocess liquid 50L, and can avoid excessive drying that contracts the recording medium. Namely, the drying unit 30 can appropriately dry a recording medium by controlling the drying strength based on at least the image forming speed (recording speed).

Specifically, the drying unit 30 (31, 32) and the image form unit 40 are disposed on the same line as illustrated in FIG. 1. For example, when the image forming speed is low, time increases for a recording medium to pass through the postprocess liquid drying unit 32. Therefore, the drying unit 30 controls the drying strength of the postprocess liquid drying unit 32 depending on the image forming speed. Accordingly, the drying unit 30 can reduce the contraction of the recording medium due to excessive drying.

Also, it is preferable to have the drying unit 30 increase the drying strength, for example, when the image forming speed is high. Also, it is preferable to have the drying unit 30 decrease the drying strength, for example, when the image forming speed is low.

Note that the image forming apparatus 100 may determine the image forming speed, for example, based on print image data transmitted from the higher-level apparatus 71 (FIG. 7) to the printer device 72 where the image forming speed is used as a parameter for controlling the application amount of the preprocess liquid 20L, the discharge amount of the postprocess liquid 50L, and the drying strength of the drying unit. Also, the image forming apparatus 100 may have a memory to store the application amount of the preprocess liquid 20L, the discharge amount of the postprocess liquid 50L, and the drying strength for ranges of image forming speed in advance, and may determine the application amount and the like for an actual printing by referring to the stored data. Furthermore, the image forming apparatus 100 may adopt a method where a user determines the application amount and the like by using a predetermined UI (user interface). Note that methods to determine the application amount and the like in the image forming apparatus 100 are not limited to those described above.

2-4. Control Based on Type of Recording Medium

It is preferable to have the image forming apparatus 100 control the preprocess unit 20, the postprocess unit 50 and the drying unit 30, further using the type of a recording medium. Note that the type of a recording medium is classified by characteristics of the recording medium such as permeability and thickness. Also, the type of a recording medium may be classified as high quality paper, recycled paper, thick paper, and the like, and/or classified by manufacturer names and product names.

For example, if using thick paper as a recording medium, the absorption amount (absorbed liquid amount) in the recording medium increases. Therefore, it is preferable to have the image forming apparatus 100 increase the application amount of the preprocess liquid 20L by the preprocess unit 20 to suppress beading. It is also preferable to have the image forming apparatus 100 increase the discharge amount of the postprocess liquid 50L by the postprocess unit 50 to sufficiently raise rub resistance (abrasion resistance). In this case, it is preferable to have the image forming apparatus 100 increase the drying strength by the drying unit 30 because the recording medium becomes hard to dry when the application amount of the preprocess liquid 20L and the discharge amount of the postprocess liquid 50L increase.

Also, for example, if using a recording medium having low permeability, it is preferable to have the image forming apparatus 100 decrease the application amount of the preprocess liquid 20L because ink droplets are hard to be absorbed by the recording medium. It is also preferable to have the image forming apparatus 100 decrease the discharge amount of the postprocess liquid 50L. Furthermore, it is preferable to have the image forming apparatus 100 decrease the drying strength in accordance with the decreased amounts of the preprocess liquid 20L and the postprocess liquid 50L.

Furthermore, by controlling the preprocess unit 20, the postprocess unit 50 and the drying unit 30 based on the type of a recording medium in addition to the image forming speed, the image forming apparatus 100 can supply more appropriate amounts of the preprocess liquid 20L and the postprocess liquid 50L on the recording medium surface to obtain an optimal dried state. This makes it possible for the image forming apparatus 100 to further suppress beading, as well as to further secure rub resistance (abrasion resistance) and glossiness. Also, for a recording medium having low absorbency or low permeability, the image forming apparatus 100 can reduce the application amount of preprocess liquid 20L and the discharge amount of the postprocess liquid 50L to reduce the cost. Furthermore, the image forming apparatus 100 can suppress insufficient drying of the recording medium, and contraction of the recording medium due to excessive drying.

Note that the image forming apparatus 100 may be configured to generate a database that stores optimal control for each combination of the preprocess unit 20, the image forming speed and the type of a recording medium, and to refer to the database in accordance with an input image forming speed and the type of a recording medium. Also, the image forming apparatus 100 may be configured to have a user to input the type of a recording medium into the image forming apparatus 100. The image forming apparatus 100 may be configured to receive as input the type of a recording medium (the type of paper such as thick paper or high quality paper, and/or the product name of the paper) through a predetermined UI (user interface). The image forming apparatus 100 may be configured to have the higher-level apparatus 71 (FIG. 7) transmit control information to the printer device 72 based on, for example, input information, to control a preprocess liquid application control unit, an after-preprocess drying control unit, a postprocess liquid application control unit, and an after-postprocess drying control unit. Also, the image forming apparatus 100 may be configured to receive recording medium information by external input entered at an external input unit attached to, for example, the printer device 72.

2-5. Control Based on Resolution of Image

It is preferable to have the image forming apparatus 100 control the preprocess unit 20, the postprocess unit 50 and the drying unit 30 further using the resolution of an image. Note that the resolution is, for example, the size of ink droplets that form an image. It is preferable to have the image forming apparatus 100 increase the application amount of the postprocess liquid 50L to sufficiently raise rub resistance (abrasion resistance), for example, when the adhesion between the recording medium and the ink is weak (when the ink droplets are large). It is preferable to have the image forming apparatus 100 increase the drying strength by the drying unit 30 because the recording medium becomes hard to dry, for example, when the application amount of the postprocess liquid 50L increases. Also, it is preferable to have the image forming apparatus 100 decrease the application amount of the postprocess liquid 50L, for example, when the resolution is higher because the size of ink droplets forming the image becomes smaller, and the adhesion between the recording medium and the ink becomes stronger.

In this way, by controlling the postprocess unit 50 and the drying unit 30 based on the resolution of an image in addition to the image forming speed, the image forming apparatus 100 can supply a more appropriate amount of the postprocess liquid 50L on the recording medium surface to obtain an optimal dried state. This makes it possible for the image forming apparatus 100 to secure sufficient rub resistance (abrasion resistance) and glossiness, as well as to shorten time required for the postprocess, to reduce the amount of the postprocess liquid 50L required for the postprocess, and to reduce the cost. Furthermore, the image forming apparatus 100 can further suppress insufficient drying of the recording medium, and contraction of the recording medium due to excessive drying. Furthermore, the image forming apparatus 100 may control the preprocess unit 20 similarly based on the resolution of an image. Accordingly, the image forming apparatus 100 can further suppress generation of beading to improve the image quality. Also, when controlling the preprocess unit 20 based on the resolution of an image, and using the drying unit 30 (31) for drying the preprocess liquid, it is preferable to have the image forming apparatus 100 control the drying unit 30 (31) similarly based on the resolution of an image.

Note that the image forming apparatus 100 may be configured to generate a database that stores optimal control for each combination of the image forming speed and the resolution of an image, and to refer to the database in accordance with an input image forming speed and the resolution of an image. Also, the image forming apparatus 100 may be configured to have a user to input the resolution of an image into the image forming apparatus 100. The image forming apparatus 100 may be configured to receive as input the resolution of an image through a predetermined UI (user interface). The image forming apparatus 100 may be configured to have the higher-level apparatus 71 (FIG. 7) transmit control information to the printer device 72 based on, for example, input information, to control a preprocess liquid application control unit, an after-preprocess drying control unit, a postprocess liquid application control unit, and an after-postprocess drying control unit. Also, the image forming apparatus 100 may be configured to receive recording medium information by external input entered at an external input unit attached to, for example, the printer device 72.

2-6. Control Based on Type of Ink

It is preferable to have the image forming apparatus 100 control the preprocess unit 20, the postprocess unit 50 and the drying unit 30 further using the type of ink. Note that the type of ink is, for example, characteristics of the ink such as viscosity and surface tension. Also, the type of ink may be classified by color, type of dye/pigment, amount, and type of resin, and/or classified by manufacturer names and product names.

For example, if using ink having low surface tension, the ink tends to spread on the recording medium after impacting on it. Therefore, it is preferable to have the image forming apparatus 100 increase the application amount of the preprocess liquid by the preprocess unit 20 to suppress beading. If using ink having low surface tension, the ink tends to permeate into the recording medium to have increased adherence. Therefore, it is also preferable to have the image forming apparatus 100 decrease the discharge amount of the postprocess liquid 50L by the postprocess unit 50. In this case, it is further preferable to have the image forming apparatus 100 decrease the drying strength by the drying unit 30 because the amount of absorbed ink on the recording medium is greater, and the postprocess liquid amount has been reduced on the recording medium.

In this way, by controlling the preprocess unit 20, the postprocess unit 50 and the drying unit 30 based on the type of ink in addition to the image forming speed, the image forming apparatus 100 can supply more appropriate amounts of the preprocess liquid 20L and the postprocess liquid 50L on the recording medium surface to obtain an optimal dried state. This makes it possible for the image forming apparatus 100 to further suppress beading, as well as to further secure rub resistance (abrasion resistance) and glossiness. Also, if using ink having low surface tension, the image forming apparatus 100 can reduce the amount of postprocess liquid 50L to reduce the cost. Furthermore, the image forming apparatus 100 can suppress insufficient drying of the recording medium, and contraction of the recording medium due to excessive drying.

Also, when controlling the preprocess unit 20 based on the type of a recording medium, and using the drying unit 30 (31) for drying the preprocess liquid, it is preferable to have the image forming apparatus 100 control the drying unit 30 (31) similarly based on the type of ink.

Note that the image forming apparatus 100 may be configured to generate a database that stores optimal control for each combination of the image forming speed and the type of ink, and to refer to the database in accordance with an input image forming speed and the resolution of an image. Also, the image forming apparatus 100 may be configured to have a user to input the type of ink into the image forming apparatus 100. The image forming apparatus 100 may be configured to receive as input the type of ink through a predetermined UI (user interface). The image forming apparatus 100 may be configured to have the higher-level apparatus 71 (FIG. 7) transmit control information to the printer device 72 based on, for example, input information, to control a preprocess liquid application control unit, an after-preprocess drying control unit, a postprocess liquid application control unit, and an after-postprocess drying control unit. Also, the image forming apparatus 100 may be configured to receive recording medium information by external input entered at an external input unit attached to, for example, the printer device 72.

Note that the control described above is based on a combination of the image forming speed (recording speed) and one of the type of a recording medium, the resolution of an image, and the type of ink, to control the preprocess unit 20, the postprocess unit 50, and the drying unit 30. However, the image forming apparatus 100 may combine the image forming speed with more than one of the type of a recording medium, the resolution of an image, and the type of ink, to control the preprocess unit 20, the postprocess unit 50, and the drying unit 30. Accordingly, the image forming apparatus 100 can dry up the preprocess liquid and postprocess liquid from the recording medium more appropriately, suppress insufficient drying of the recording medium and contraction of the recording medium due to excessive drying, and perform image forming more stably.

### EXAMPLES

Examples of image forming apparatuses will be described according to the above embodiments of the present invention.

### First Example

An image forming apparatus 100E will be described as a first example.

(Configuration of Image Forming Apparatus), (Take-in Unit), (Preprocess Unit), (Drying Unit), (Image Forming Unit), (Postprocess Unit), (Take-Out Unit) and (Control Unit)

FIGS. 1 to 5 illustrate a configuration and the like of the image forming apparatus 100E according to the present example. As shown in FIGS. 1-5, the configuration and the like of the image forming apparatus 100E according to the present example are basically the same as those of the image forming apparatus 100 according to the above embodiments, and their description is omitted.

(Configuration of Control Unit)

FIGS. 7 to 10 illustrate the configuration and the like of the control unit 70 of the image forming apparatus 100E according to the present example. As shown in FIGS. 7-10, the configuration and the like of the control unit 70 of the image forming apparatus 100E according to the present example are basically the same as those of the control unit 70 of the image forming apparatus 100 according to the above embodiments, and different parts will be mainly described.

The control unit 70 according to the present example determines the image forming speed of an image formed on a recording medium.

The control unit 70 determines the image forming speed of an image formed on a recording medium based on information input into the image forming apparatus 100E by a user according to the present example.

(Operations of Forming Image)

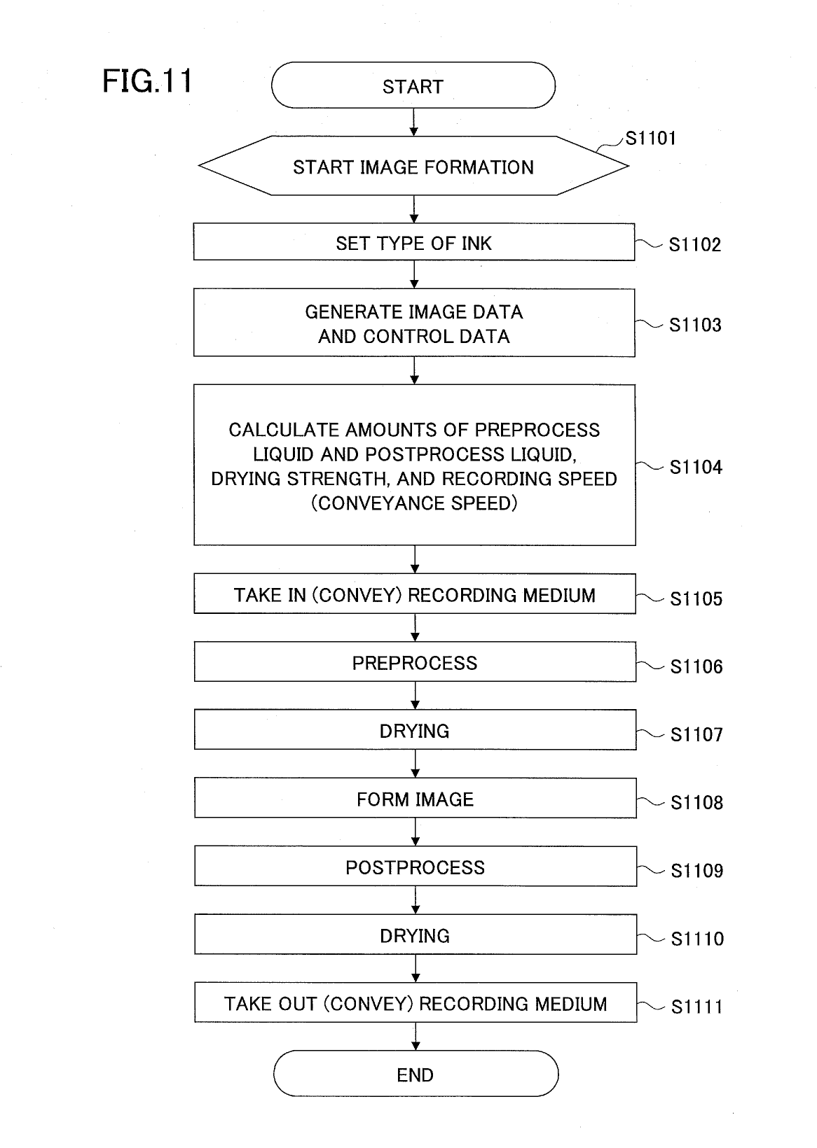

Operations of forming an image executed by the image forming apparatus 100E according to the present example will be described with reference to FIG. 11. Note that the operations of forming an image by the image forming apparatus 100E described below can be used for operations of printing an image on a recording medium.

As shown in FIG. 11, the image forming apparatus 100E according to the present example starts forming (or printing) an image based on print job data input from the outside of the image forming apparatus 100E at Step S1101. Also, the image forming apparatus 100E stores the input print job data in the HDD 71d of the higher-level device 71.

After the start, the image forming apparatus 100E proceeds to Step S1102.

Next, at Step S1102, the image forming apparatus 100E determines the image forming speed using the control unit 70, and sets (stores) the determined image forming speed in the HDD 71d of the higher-level device 71.

Note that the control unit 70 may further store information about the recording medium (physical properties of the recording medium such as physical properties of the paper material, paper thickness, and paper area)) input from the outside of the image forming apparatus 100E. Also, the control unit 70 may store the image forming speed and the like by associating it with one of variations of the image forming speed stored beforehand in the HDD 71d of the higher-level device 71. Accordingly, the control unit 70 can read out the image forming speed and the like using the associated variation of the image forming speed in later operations. Note that the variations of the image forming speed and the like may be stored in advance by the user in the HDD 71d of the higher-level device 71 in the image forming apparatus 100E.

Then, the image forming apparatus 100E proceeds to Step S1103.

At Step S1103, the image forming apparatus 100E generates print image data, control data and the like using the higher-level device 71 of the control unit 70. Specifically, the higher-level device 71 of the control unit 70 generates the print image data, the control data and the like based on the print job data and at least the image forming speed stored in the HDD 71d.

Then, the process of the image forming apparatus 100E proceeds to Step S1104.

At Step S1104, the image forming apparatus 100E determines an amount of the preprocess liquid (application amount in the present example) and an amount of the postprocess liquid (discharge amount in the present example) using the control unit 70. Then, the image forming apparatus 100E proceeds to Step S1105.

Specifically, the control unit 70 calculates the application amount of the preprocess liquid 20L of the preprocess unit 20 and the discharge amount of the postprocess liquid 50L of the postprocess unit 50 based on at least the image forming speed. The control unit 70 may increase the application amount of the preprocess liquid 20L when the image forming speed is high. Also, the control unit 70 may decrease the application amount of the preprocess liquid 20L when the image forming speed is low. Furthermore, the control unit 70 can increase the discharge amount of the postprocess liquid when the application amount of the preprocess liquid is increased.

Namely, the control unit 70 may calculate the amount of liquid (application amount) of the preprocess liquid 20L, and may calculate the drying strength and the discharge amount of the postprocess liquid 50L based on at least the image forming speed. The calculation of the drying strength and the discharge amount of the postprocess liquid 50L includes at least the calculation of the drying strength and the discharge amount of the postprocess liquid 50L based on the calculated application amount of the preprocess liquid 20L. Accordingly, even when the image forming speed is high, which could degrade the rub resistance of an image to be formed, the image forming apparatus 100E can improve the rub resistance of the recording medium having the image formed, by increasing the drying strength at Step S1107 and increasing the discharge amount of the postprocess liquid 50L at Step S1109, as will be described later.

Note that when increasing the application amount of the preprocess liquid 20L, the control unit 70 may increase the adhesion amount of the preprocess liquid 20L on the recording medium greater than or equal to 1.5 g/m². Also, when increasing the discharge amount of the postprocess 50L liquid, the control unit 70 may increase the adhesion amount of the postprocess liquid 50L on the recording medium to more than 1.2 g/m². On the other hand, when decreasing the application amount of the preprocess liquid 20L and the discharge amount of the postprocess liquid 50L, the control unit 70 may decrease the adhesion quantities less than 1.5 g/m² and 1.2 g/m², respectively. Also, when decreasing the application amount of the preprocess liquid 20L and the discharge amount of the postprocess liquid 50L, the control unit 70 may not apply the preprocess liquid 20L and may not discharge the postprocess liquid 50L. Furthermore, the control unit 70 may appropriately change the application amount of the preprocess liquid 20L and the discharge amount of the postprocess liquid 50L depending on physical properties of the recording medium.

After the calculation of the amount of the preprocess liquid 20L and the amount of the postprocess liquid 50L, the image forming apparatus 100E proceeds to Step S1105. Note that the image forming apparatus 100E may have a configuration where the amount of the preprocess liquid 20L and the amount of the postprocess liquid 50L corresponding to the image forming speed are selected by the user through an UI (user interface), among amounts stored in advance.

At Step S1105, the image forming apparatus 100E takes in (conveys) the recording medium to the preprocess unit 20 by using the take-in unit 10 (FIG. 1). Note that the image forming apparatus 100E may start Step S1105 soon after forming an image at Step S1101. After starting the conveyance, the image forming apparatus 100E proceeds to Step S1106.

At Step S1106, the image forming apparatus 100E performs the preprocess by using the preprocess unit 20 (FIG. 1). Specifically, the preprocess unit 20 controls a nip pressure by using the pressure adjustment unit 25 (FIG. 2) based on the application amount of the preprocess liquid 20L calculated at Step S1104 to control (change) the application amount (film thickness or the like) of the preprocess liquid 20L. Note that the preprocess unit 20 may control the application amount of the preprocess liquid 20L by changing the rotational speed of the application roller 23 (FIG. 2). By controlling the application amount of the preprocess liquid 20L of the preprocess unit 20, the image processing apparatus 100E can suppress blurring of an image (ink) that could be formed afterward.

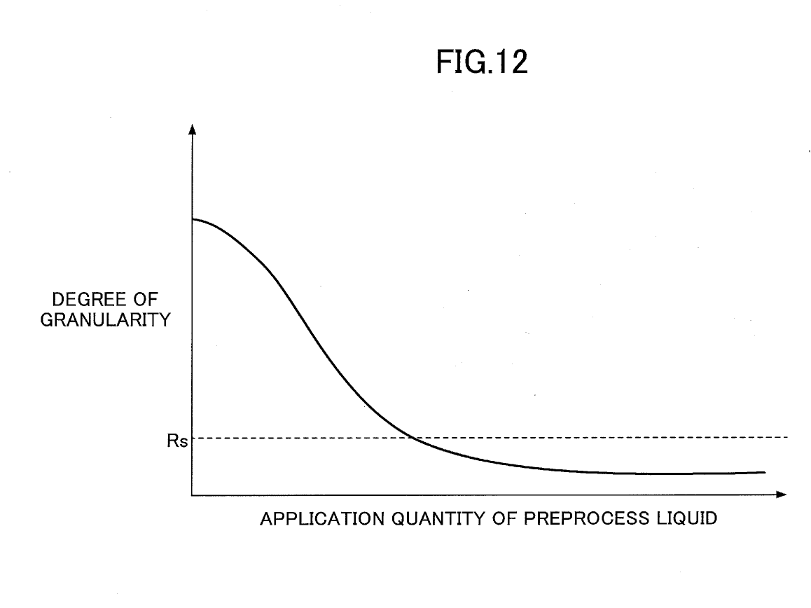

For example, as shown in FIG. 12, the image forming apparatus 100E can make granularity (beading) of ink smaller that is discharged when an image is formed, by increasing the application amount of the preprocess liquid 20L of the preprocess unit 20. Namely, by increasing the application amount of the preprocess liquid 20L of the preprocess unit 20, the image forming apparatus 100E can make the granularity (beading) of the ink used for forming the image less than or equal to a predetermined granularity Rs. The predetermined granularity Rs may be defined as a granularity with which the ink on the recording medium is hard to blur. Also, the predetermined granularity Rs may be determined in advance experimentally or by numerical calculations.

The image forming apparatus 100E then conveys the recording medium to the preprocess liquid drying unit 31 (FIG. 1) to proceed to Step S1107.

At Step S1107, the image forming apparatus 100E dries the recording medium by using the preprocess liquid drying unit 31 (FIG. 1). The preprocess liquid drying unit 31 dries the recording medium based on the drying strength for the preprocess liquid determined at Step S1104.

The image forming apparatus 100E then conveys the recording medium to the image forming unit 40 (FIGS. 1 and 4) to proceed to Step S1108.

At Step S1108, the image forming apparatus 100E forms an image on a surface of the recording medium using the image forming unit 40, based on the print image data generated at Step S1103, as the image forming step. Note that the image forming unit 40 may form the image further using the type of the recording medium and the resolution of the image to be formed. Also, the image forming unit 40 may control the operations of forming the image by controlling the voltage (drive voltage) applied to the piezoelectric element 45P (pressure generation unit 45 in FIG. 4).

The image forming apparatus 100E then conveys the recording medium to the postprocess unit 50 (FIG. 1) to proceed to Step S1109.

At Step S1109, the image forming apparatus 100E performs the postprocess on the recording medium by using the postprocess unit 50, as the postprocess step.

Specifically, based on the discharge amount calculated at Step S1104 and the image data relating to the postprocess generated at Step S1103, the postprocess unit 50 deposits (discharges) the postprocess liquid 50L onto a specific part in the region where the image has been formed on the recording medium. Note that the postprocess unit 50 may control the discharge amount discharged onto the recording medium, based on the image data relating to postprocessing, by using the postprocess liquid output unit 72Ep.

The image forming apparatus 100E then conveys the recording medium to the postprocess liquid drying unit 32 (FIG. 1) to proceed to Step S1110.

At Step S1110, the image forming apparatus 100E dries the recording medium using the postprocess liquid drying unit 32 (heat rollers). The postprocess liquid drying unit 32 dries the recording medium based on the drying strength determined at Step S1104. After the drying, the image forming apparatus 100E proceeds to Step S1111.

At Step S1111, the image forming apparatus 100E conveys (takes out) the recording medium by using the take-out unit 60 (FIG. 1). The process of the image forming apparatus 100E then proceeds to END in FIG. 11 to conclude the operations of forming the image.

Thus, the image forming apparatus 100E according to the first example can obtain the same effect as the image forming apparatus 100 according to the above embodiments. Also, the image forming apparatus 100E according to the present example can manufacture a product or can print printed matter by forming or printing an image on the recording medium at Steps S1101 to S1113. Note that the manufactured product or printed matter obtained by the image forming apparatus 100E according to the present example has a cross-sectional form, for example, as shown in FIG. 6.

### Second Example

An image forming apparatus 200E will be described as a second example.

(Configuration of Image Forming Apparatus), (Take-in Unit), (Preprocess Unit), (Drying Unit), (Image Forming Unit), (Postprocess Unit), (Take-Out Unit) and (Control Unit)

FIGS. 1 to 5 illustrate a configuration and the like of the image forming apparatus 200E according to the present example. As shown in FIGS. 1-5, the configuration and the like of the image forming apparatus 200E according to the present example are basically the same as those of the image forming apparatus 100E according to the first example, and their description is omitted.

(Configuration of Control Unit)

FIGS. 7 to 10 illustrate the configuration and the like of the control unit 70 of the image forming apparatus 200E according to the present example. As shown in FIGS. 7-10, the configuration and the like of the control unit 70 of the image forming apparatus 200E according to the present example are basically the same as those of the control unit 70 of the image forming apparatus 100E according to the first example, and different parts will be mainly described.

The flowchart of the first example (FIG. 11) does not include a process of adjustment (recalculation) of the liquid amount (discharge amount) of the postprocess liquid 50L. The control unit 70 according to the present example includes a process of adjustment (recalculation) of the liquid amount (discharge amount) of the postprocess liquid 50L based on at least the image forming speed.

(Operations of Forming Image)

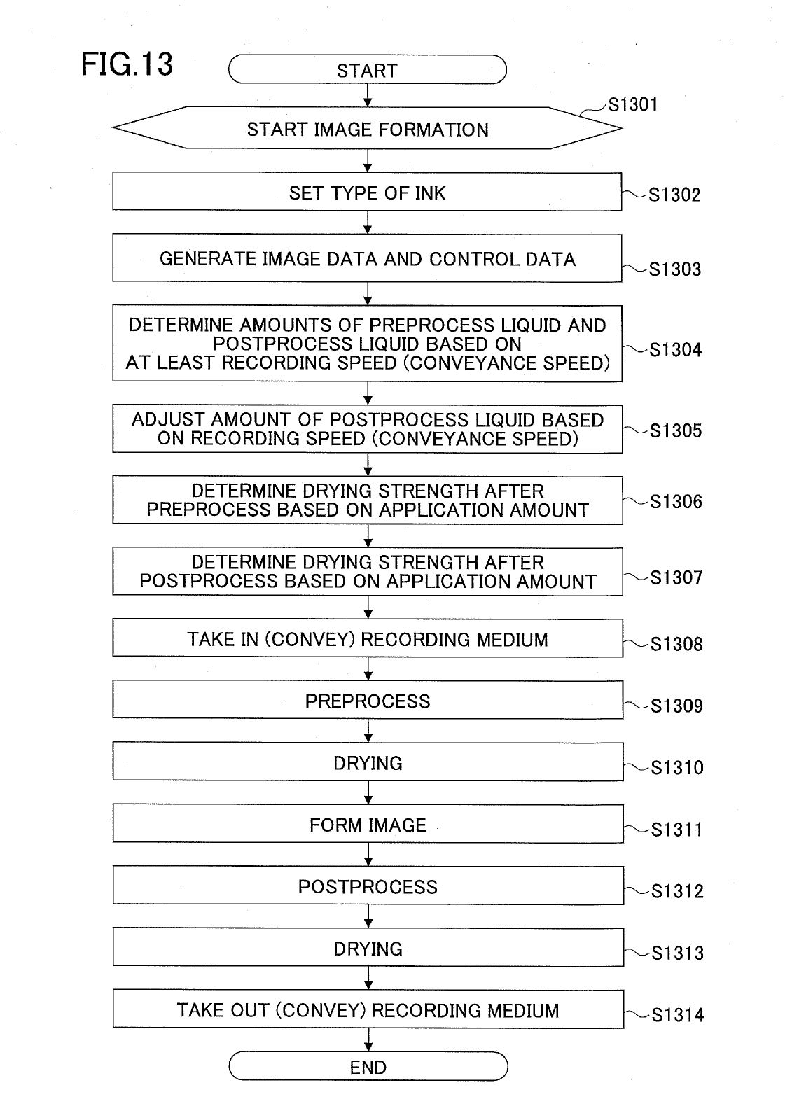

Operations of forming an image executed by the image forming apparatus 200E according to the present example will be described with reference to FIG. 13. Note that the operations of forming an image by the image forming apparatus 200E described below can be used for operations of printing an image on a recording medium.

As shown in FIG. 13, the image forming apparatus 200E performs Steps S1301 to S1304 similarly to Steps S1101 to S1104 performed by the image forming apparatus 100E of the first example. Then, the image forming apparatus 200E proceeds to Step S1305.

At Step S1305, the image forming apparatus 200E adjusts (recalculates) the liquid amount (discharge amount) of the postprocess liquid 50L based on the image forming speed using the control unit 70. Then, the image forming apparatus 200E proceeds to Step S1306.

At Step S1306, the image forming apparatus 200E determines the preprocess liquid drying strength using the control unit 70. Here, the control unit 70 determines the preprocess liquid drying strength based on the liquid amount of the preprocess liquid 50L calculated at Step S1304 according to the present example. Then, the image forming apparatus 200E proceeds to Step S1307.

At Step S1307, the image forming apparatus 200E determines the postprocess liquid drying strength using the control unit 70. Here, the control unit 70 determines the postprocess liquid drying strength based on the liquid amount of the postprocess liquid calculated at Step S1304 according to the present example. Then, the image forming apparatus 200E proceeds to Step S1308.

Next, the image forming apparatus 200E performs Steps S1308 to S1314 similarly to Steps S1107 to S1113 performed by the image forming apparatus 100E of the first example.

Thus, the image forming apparatus 200E according to the second example can obtain the same effect as the image forming apparatus 100E according to the first example. Note that although the liquid amount in the postprocess is adjusted (recalculated) here, the liquid amount in the preprocess may also be adjusted based on information about the recording medium.

Also, the image forming apparatus 200E according to the present example can manufacture a product or can print printed matter by forming or printing an image on the recording medium at Steps S1301 to S1314. Note that the manufactured product or printed matter obtained by the image forming apparatus 200E according to the present example has a cross-sectional form, for example, as shown in FIG. 6.

Further, the present invention is not limited to these embodiments and examples described above, but various variations and modifications may be made without departing from the scope of the present invention.

The present application is based on and claims the benefit of priority of Japanese Priority Application No. 2013-174369 filed on Aug. 26, 2013, with the Japanese Patent Office, the entire contents of which are hereby incorporated by reference.

What is claimed is:

1. An image forming apparatus discharging liquid droplets onto a recording medium to form an image on a surface of the recording medium, comprising:
a preprocess unit configured to apply a preprocess liquid to the surface of the recording medium before the image is formed; and
a postprocess unit configured to discharge a postprocess liquid onto the surface of the recording medium after the image has been formed, the postprocess liquid being different from the preprocess liquid,
wherein the preprocess unit applies the preprocess liquid with an amount of the preprocess liquid determined based on at least image forming speed of the image to be formed on the recording medium,
wherein the postprocess unit discharges the postprocess liquid with an amount of the postprocess liquid determined based on at least the image forming speed.

2. The image forming apparatus as claimed in claim 1, wherein the preprocess unit increases the amount of the preprocess liquid while the image forming speed increases.

3. The image forming apparatus as claimed in claim 1, wherein the postprocess unit increases the amount of the postprocess liquid while the image forming speed increases.

4. The image forming apparatus as claimed in claim 1, further comprising:
a preprocess liquid drying unit configured to dry the preprocess liquid having been applied to the surface of the recording medium; and
a postprocess liquid drying unit configured to dry the postprocess liquid having been discharged on the surface of the recording medium,
wherein the preprocess liquid drying unit controls drying strength for the preprocess liquid based on at least the image forming speed,
wherein the postprocess liquid drying unit controls drying strength for the postprocessing liquid based on at least the image forming speed.

5. The image forming apparatus as claimed in claim 4, wherein the preprocess liquid drying unit increases the drying strength for the preprocess liquid while the image forming speed increases,
wherein the postprocess liquid drying unit increases the drying strength for the postprocess liquid while the image forming speed increases.

6. The image forming apparatus as claimed in claim 4, wherein the amount of the preprocess liquid, the amount of the postprocess liquid, the drying strength of the preprocess liquid, and/or the drying strength of the postprocess liquid are determined by further using a type of the recording medium, a resolution of the image to be formed and/or a type of ink for forming the image.

7. An image forming method executed by a processor, the method comprising:
applying a preprocess liquid to a surface of a recording medium;
forming an image on the recording medium having the preprocess liquid applied; and
discharging a postprocess liquid onto the surface of the recording medium having the image formed, the preprocess liquid being different from the preprocess liquid,
wherein the applying applies the preprocess liquid with an amount of the preprocess liquid determined based on at least image forming speed of the image to be formed on the recording medium,
wherein the discharging discharges the postprocess liquid with an amount of the postprocess liquid determined based on at least the image forming speed.

8. The image forming method as claimed in claim 7, the method further comprising:
drying the preprocess liquid having been applied to the surface of the recording medium; and
drying the postprocess liquid having been discharged on the surface of the recording medium.

9. A printed matter printed by the image forming method as claimed in claim 7.
